(19) United States
(12) Patent Application Publication
(10) Pub. No.: US 2026/0052049 A1
(43) Pub. Date: Feb. 19, 2026

(54) Methods And Apparatus For Reference Signal Transmission In Integrated Sensing And Communication Systems

(71) Applicant: MediaTek Singapore Pte. Ltd., Singapore (SG)

(72) Inventors: Haoran Li, Beijing (CN); Wenze Qu, Beijing (CN); Rui Zhang, San Jose, CA (US); Min Lei, Beijing (CN); Xuanbo Shao, Beijing (CN); Tao Chen, Beijing (CN)

(73) Assignee: MediaTek Singapore Pte. Ltd., Singapore (SG)

(21) Appl. No.: 19/301,285

(22) Filed: Aug. 15, 2025

(30) Foreign Application Priority Data
Aug. 19, 2024 (WO) PCT/CN2024/113159
Nov. 26, 2024 (WO) PCT/CN2024/134472
Jan. 8, 2025 (WO) PCT/CN2025/071322
Aug. 7, 2025 (CN) 202511107816.9

(51) Int. Cl. H04L 27/26; H04L 5/00

(52) U.S. Cl. CPC H04L 27/261; H04L 5/0005; H04L 27/2678

(57) ABSTRACT

Various solutions for Reference Signal (RS) transmission with respect to an apparatus in mobile communications are described. The apparatus may determine an RS pattern set. The RS pattern set may include at least one RS pattern. The at least one RS pattern may be configured using a symbol-based configuration or a slot-based configuration. The apparatus may transmit a plurality of RSs based on the RS pattern set.

### CROSS REFERENCE TO RELATED PATENT APPLICATION(S)

The present disclosure is part of a non-provisional application claiming the priority benefit of PCT Application No. PCT/CN2024/113159, filed on 19 Aug. 2024, PCT Application No. PCT/CN2024/134472, filed on 26 Nov. 2024, PCT Application No. PCT/CN2025/071322, filed on 8 Jan. 2025, and CN application No. 202511107816.9, filed on 7 Aug. 2025, the contents of which herein being incorporated by reference in their entirety.

### TECHNICAL FIELD

The present disclosure is generally related to mobile communications and, more particularly, to Reference Signal (RS) transmission with respect to apparatus in mobile communications such as integrated sensing and communication systems.

### BACKGROUND

Unless otherwise indicated herein, approaches described in this section are not prior art to the claims listed below and are not admitted as prior art by inclusion in this section.

In New Radio (NR) mobile communications, Integrated Sensing and Communication (ISAC) systems have been developed. In particular, an ISAC system may enable simultaneous environmental sensing and wireless communication by reusing shared waveform resources (e.g., Orthogonal Frequency-Division Multiplexing (OFDM) signals). In an ISAC system, Reference Signals (RSs) may constitute a fundamental basis for achieving sensing accuracy, resolution, and target detection capability, and therefore require careful configuration to support dual-function operations.

However, existing RS configurations may not be sufficient/efficient for an OFDM-based ISAC system. In particular, the existing RS configurations with fixed time-frequency spacing may cause ambiguity peaks in delay-Doppler estimation and often incur excessive overhead when high sensing resolution is needed. Such RS configurations may lack flexibility to adapt to diverse sensing scenarios while maintaining communication efficiency. Furthermore, Cyclic Prefix (CP) length is primarily designed to eliminate inter-symbol interference (ISI) caused by multipath delay in communication scenarios, which limits the maximum sensing range. For example, with a subcarrier spacing of 60 kHz, the CP duration corresponds to approximately 1.17 μs, supporting a sensing range of less than 200 meters. This is insufficient for practical sensing applications such as UAV detection or remote object tracking, which may demand coverage beyond 500 meters.

Accordingly, how to improve RS design in the ISAC system becomes a critical challenge in the newly developed wireless communication network. Therefore, there is a need for improving RS transmission in the ISAC system.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to Reference Signal (RS) transmission with respect to apparatus in mobile communications.

In one aspect, a method may involve an apparatus determining an RS pattern set. The RS pattern set may include at least one RS pattern. The RS pattern may also be referred to as a T-F RS cluster. The at least one RS pattern may be configured using a symbol-based configuration or a slot-based configuration. The method may further involve the apparatus transmitting a plurality of RSs based on the RS pattern set.

In one aspect, a method may involve an apparatus receiving a plurality of RSs. The method may further involve the apparatus processing the plurality of RSs based on an RS pattern set, wherein the RS pattern set includes at least one RS pattern, and the at least one RS pattern is configured using a symbol-based configuration or a slot-based configuration.

In one aspect, an apparatus may comprise a transceiver which, during operation, wirelessly communicates with a wireless network. The apparatus may also comprise a processor communicatively coupled to the transceiver. The processor, during operation, may perform operations comprising determining an RS pattern set. The RS pattern set may include at least one RS pattern, and the at least one RS pattern may be configured using a symbol-based configuration or a slot-based configuration. The processor may further perform operations comprising transmitting, via the transceiver, a plurality of RSs based on the RS pattern set.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1A is a diagram depicting an example scenario under schemes in accordance with implementations of the present disclosure.

FIG. 1B is a diagram depicting an example scenario under schemes in accordance with implementations of the present disclosure.

FIG. 2A is a diagram depicting an example scenario under schemes in accordance with implementations of the present disclosure.

FIG. 2B is a diagram depicting an example scenario under schemes in accordance with implementations of the present disclosure.

FIG. 2C is a diagram depicting an example scenario under schemes in accordance with implementations of the present disclosure.

FIG. 3A is a diagram depicting an example scenario under schemes in accordance with implementations of the present disclosure.

FIG. 3B is a diagram depicting an example scenario under schemes in accordance with implementations of the present disclosure.

FIG. 3C is a diagram depicting an example scenario under schemes in accordance with implementations of the present disclosure.

FIG. 4 is a diagram depicting an example scenario under schemes in accordance with implementations of the present disclosure.

FIG. 5A is a diagram depicting an example scenario under schemes in accordance with implementations of the present disclosure.

FIG. 5B is a diagram depicting an example table under schemes in accordance with implementations of the present disclosure.

FIG. 5C is a diagram depicting an example scenario under schemes in accordance with implementations of the present disclosure.

FIG. 6 is a diagram depicting an example scenario under schemes in accordance with implementations of the present disclosure.

FIG. 7 is a diagram depicting an example scenario under schemes in accordance with implementations of the present disclosure.

FIG. 8 is a diagram depicting an example scenario under schemes in accordance with implementations of the present disclosure.

FIG. 9 is a diagram depicting an example scenario under schemes in accordance with implementations of the present disclosure.

FIG. 10A is a diagram depicting an example scenario under schemes in accordance with implementations of the present disclosure.

FIG. 10B is a diagram depicting an example scenario under schemes in accordance with implementations of the present disclosure.

FIG. 11A is a diagram depicting an example scenario under schemes in accordance with implementations of the present disclosure.

FIG. 11B is a diagram depicting an example scenario under schemes in accordance with implementations of the present disclosure.

FIG. 12 is a block diagram of an example communication system in accordance with an implementation of the present disclosure.

FIG. 13 is a flowchart of an example process in accordance with an implementation of the present disclosure.

FIG. 14 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to RS transmission with respect to apparatus in mobile communications. According to the present disclosure, a number of possible solutions may be implemented separately or jointly. That is, although these possible solutions may be described below separately, two or more of these possible solutions may be implemented in one combination or another.

In some scenarios, an Integrated Sensing and Communication (ISAC) system may refer to a system architecture in which wireless communication and environmental sensing functionalities may be jointly designed and operated using shared resources. The ISAC system may enable a transceiver (e.g., a network node or a User Equipment (UE)) to simultaneously perform data transmission and acquire sensing parameters (e.g., range, velocity, angle) based on reflected or received signals, thereby improving spectral efficiency, hardware reuse, and system-level integration.

Further, in a monostatic sensing architecture of the ISAC system, the transmitting end and the receiving end may be co-located, such that sensing may be performed based on reflections of signals transmitted by the same device. In a bistatic sensing architecture of ISAC systems, the transmitting end and the receiving end may be physically separated, and sensing may be performed by the receiving end based on reflections of signals transmitted by the transmitting end.

Regarding the present disclosure, in ISAC systems, a transmitter may determine a Reference Signal (RS) pattern set. The RS pattern set may include at least one RS pattern. The at least one RS pattern may be configured using a symbol-based configuration or a slot-based configuration. Then, the transmitter may transmit a plurality of RSs to a receiver based on the RS pattern set. After receiving the plurality of RSs, the receiver may process the plurality of RSs based on the RS pattern set.

In particular, the RS pattern set may include a multi-level RS framework, using the RS pattern as a unit, which may enable scalability and flexibility across diverse network requirements. Accordingly, the scalable and flexible RS configuration framework (i.e., the RS pattern set including the RS pattern(s)) may significantly enhance overall network efficiency.

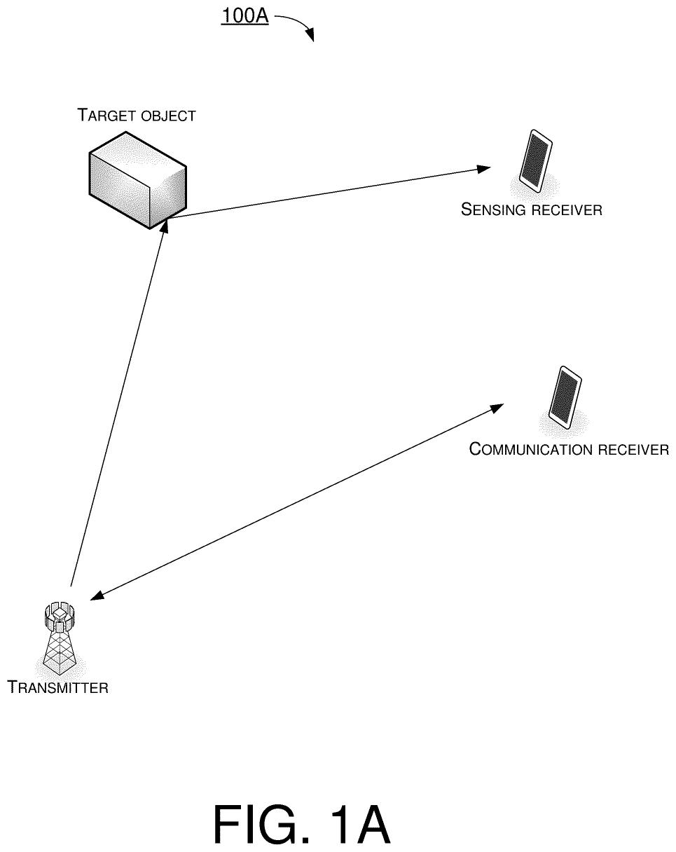

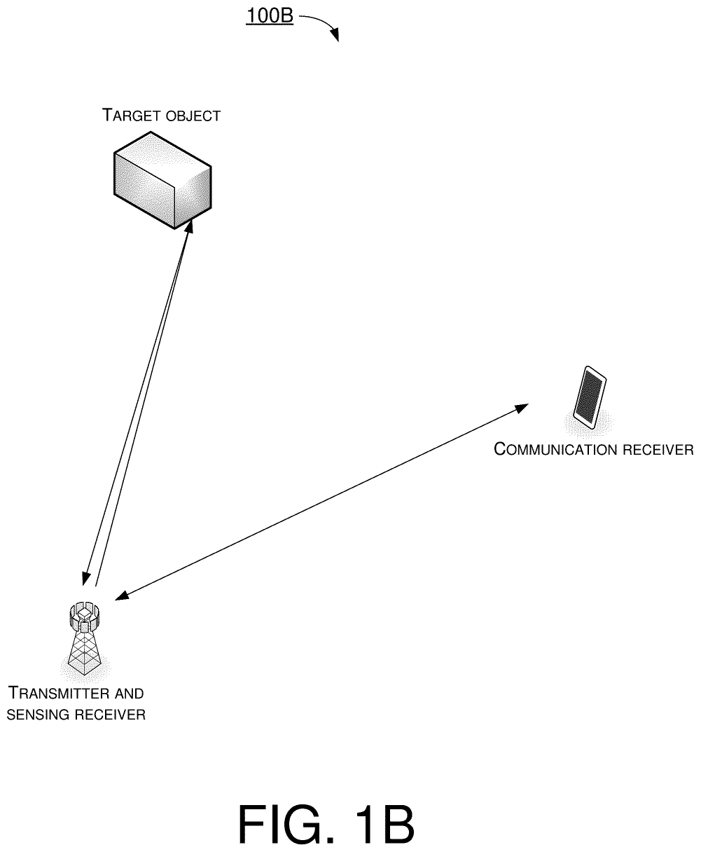

FIG. 1A illustrates an example scenario 100A under schemes in accordance with implementations of the present disclosure. Scenario 100A involves a transmitter (i.e., a network node) and sensing/communication receivers (i.e., UEs), which may be a part of a wireless communication network (e.g., an LTE network, a 5G/NR network, an IoT network or a 6G network). Scenario 100A illustrates the current bistatic ISAC network framework. The transmitter and the sensing receiver may not be co-located. It should be noted that the designation of the transmitter as the network node and the sensing/communication receivers as the UEs is for illustrative purposes and is not intended to be limiting.

FIG. 1B illustrates an example scenario 100B under schemes in accordance with implementations of the present disclosure. Scenario 100B involves a transmitter (i.e., a network node), a sensing receiver (i.e., the network node), and a communication receiver (i.e., a UE), which may be a part of a wireless communication network (e.g., an LTE network, a 5G/NR network, an IoT network or a 6G network). Scenario 100B illustrates the current monostatic ISAC network framework. The transmitter and the sensing receiver may be co-located. It should be noted that the designation of the transmitter and the sensing receiver as the network node and the communication receiver as the UE is for illustrative purposes and is not intended to be limiting.

In some embodiments, the transmitter may determine an RS pattern set. The RS pattern set may include at least one RS pattern. The at least one RS pattern may be configured using a symbol-based configuration or a slot-based configuration. More specifically, the slot-based configuration may correspond to a configuration in which RSs are aligned within predefined slot durations (e.g., a 14-symbol slot in 5G NR). The symbol-based configuration may correspond to a configuration in which RSs are scheduled at an individual symbol level independent of slot boundaries (i.e., the scheduling granularity of reference signals (RSs) may be configured at the level of one or more OFDM symbols). Then, the transmitter may transmit a plurality of RSs to a receiver based on the RS pattern set. After receiving the plurality of RSs, the receiver may process the plurality of RSs based on the RS pattern set.

In some implementations, the RS pattern set may be implemented as a multi-level RS framework, using one RS pattern as a unit. In particular, one RS pattern may serve as a first-level unit. In some cases, a plurality of first-level RS patterns may constitute a second-level RS structure. In some cases, a plurality of second-level RS structures may constitute a third-level RS structure if necessary. In general, (n−1)^{th}-level RS structures may form the RS pattern set having an n-level RS framework.

In some cases, the RS pattern set may be implemented as a two-level RS framework. Specifically, at the first level, one RS pattern may serve as a first-level unit. At the second level, multiple RS patterns (i.e., at least two RS patterns) may form a second-level RS structure which may be referred to as an RS burst. In these cases, one RS burst may form the RS pattern set (i.e., the RS pattern set may be one RS burst).

In some cases, the RS pattern set may be implemented as a three-level RS framework. Specifically, at the first level, one RS pattern serves as a first-level unit. At the second level, multiple RS patterns (i.e., at least two RS patterns) may form a second-level RS structure which may be referred to as an RS burst. At the third level, multiple RS bursts (i.e., at least two RS bursts) may form a third-level RS structure which may be referred to as the RS pattern set.

It should be noted that the multi-level RS framework may be degenerated a single-level RS framework. Specifically, one RS pattern may serve as a first-level unit. In these cases, one RS pattern may form the RS pattern set, i.e., the RS pattern set may be one RS pattern.

In some implementations, the RS pattern set may include a plurality of RS patterns configured across at least one of the time domain and the frequency domain. In some cases, the plurality of RS patterns may be configured across the time domain. In some cases, the plurality of RS patterns may be configured across the frequency domain. In some cases, the plurality of RS patterns may be configured across both the time domain and frequency domain.

In some implementations, parameter(s) may be associated with the first-level for defining the RS pattern. The parameter(s) may include at least one of: (1) a Resource Element (RE) spacing S_{sub} between two REs within one symbol carrying RSs (in unit of RE), (2) staggering offset

$${F}_{m}^{intra}$$

for m^{th} symbol carrying RSs (in unit of subcarrier), (3) symbol spacing S_{sym} between two symbols carrying RSs (in unit of symbol), and (4) a number of symbols U_{F} carrying RSs in one RS pattern.

It should be noted that the staggering offset may denote the frequency sub-carrier level shift applied per RS symbol, and the staggering offset is required to be equal to or less than the RE spacing. In some cases, the staggering offsets corresponding to different RS symbols in the RS pattern may be the same or different.

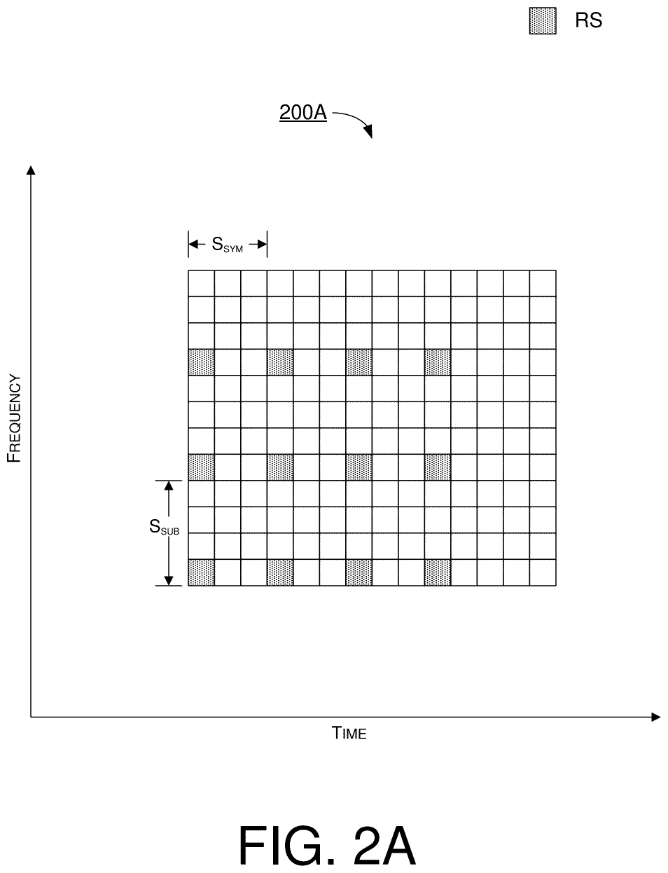

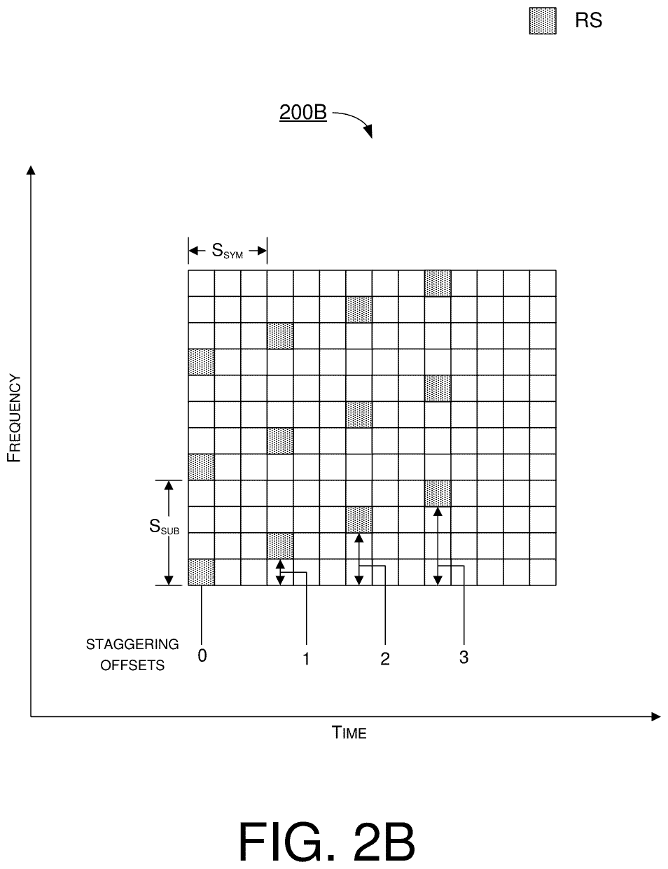

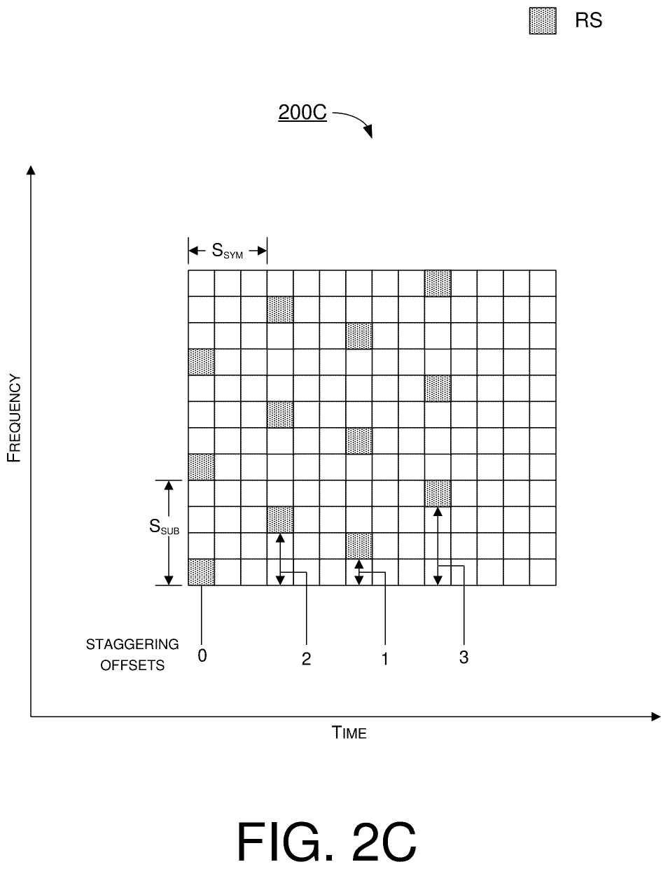

FIG. 2A illustrates an example scenario 200A under schemes in accordance with implementations of the present disclosure. For example, an RS pattern without staggering offset (i.e., staggering offset

$${F}_{m}^{intra}$$

for m^{th} symbol carrying RSs are all the same as zero) is shown in FIG. 2A when S_{sub} is 4, S_{sym} is 3 and U_{F} is 4. The RS pattern in this example is referred to as the no-staggering RS pattern.

FIG. 2B illustrates an example scenario 200B under schemes in accordance with implementations of the present disclosure. For example, an RS pattern is shown in FIG. 2B when S_{sub} is 4, S_{sym} is 3, U_{F} is 4, and staggering offset

$${F}_{m}^{intra} = mod ( {p}_{slope} \cdot m + {β}_{1} , {S}_{sub} )$$

where pₛₗₒₚₑ is relative prime to S_{sub} and β₁ϵ{0, 1, . . . S_{sub}−1}, β₁ is initial staggering offset, m=0, 1, . . . U_{F}−1 is index of symbol carrying RSs within one RS pattern. In this example, the staggering offsets for the symbols of the RS pattern are different as {0, 1, 2, 3}, and the RS pattern in this example is referred to as a staggering A RS pattern.

FIG. 2C illustrates an example scenario 200C under schemes in accordance with implementations of the present disclosure. For example, an RS pattern is shown in FIG. 2C when S_{sub} is 4, S_{sym} is 3, U_{F} is 4, and the staggering offset is defined such that no integer pair (κ₁ϵ{1, 2, . . . , S_{sub}−1}, κ₂ϵ [symbol] ) exists that satisfies the following system of modulo equations:

$$mod ( m {κ}_{2} - ( {F}_{m}^{intra} - {F}_{0}^{intra} ) {κ}_{1} , {S}_{sub} ) = 0 , for m = 0 , 1 , … {U}_{F} - 1 , {F}_{m}^{intra} = {F}_{mod ( m , {U}_{F} )}$$

In this example, the staggering offsets for the symbols of the RS pattern are different as {0, 2, 1, 3}, and the RS pattern in this example is referred to as the staggering B RS pattern.

In some implementations, parameter(s) may be associated with the second-level for defining the RS burst in the time domain or the frequency domain. The parameter(s) may include at least one of: (1) a number of RS patterns N_{F}≥1 forming one RS burst, (2) a burst spacing S_{sec} between two RS bursts in the time domain (in unit of symbol), (3) an RE spacing S_{sub,2} between a first RE included in one RS pattern and a second RE included in an adjacent RS pattern in the frequency domain (in unit of RE), and (4) a number of RS bursts Q in the RS pattern set.

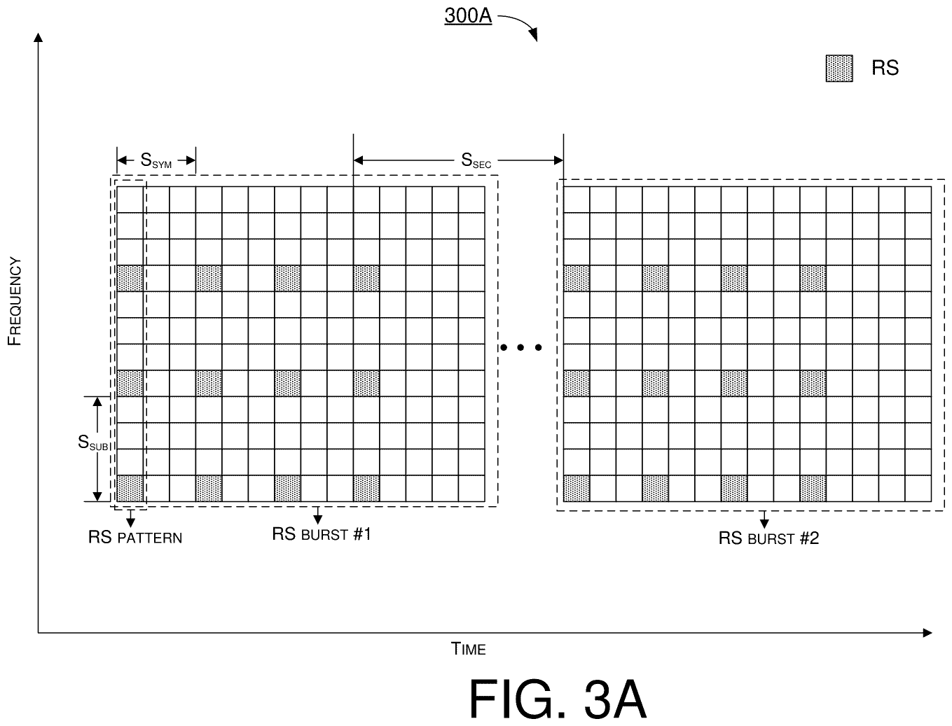

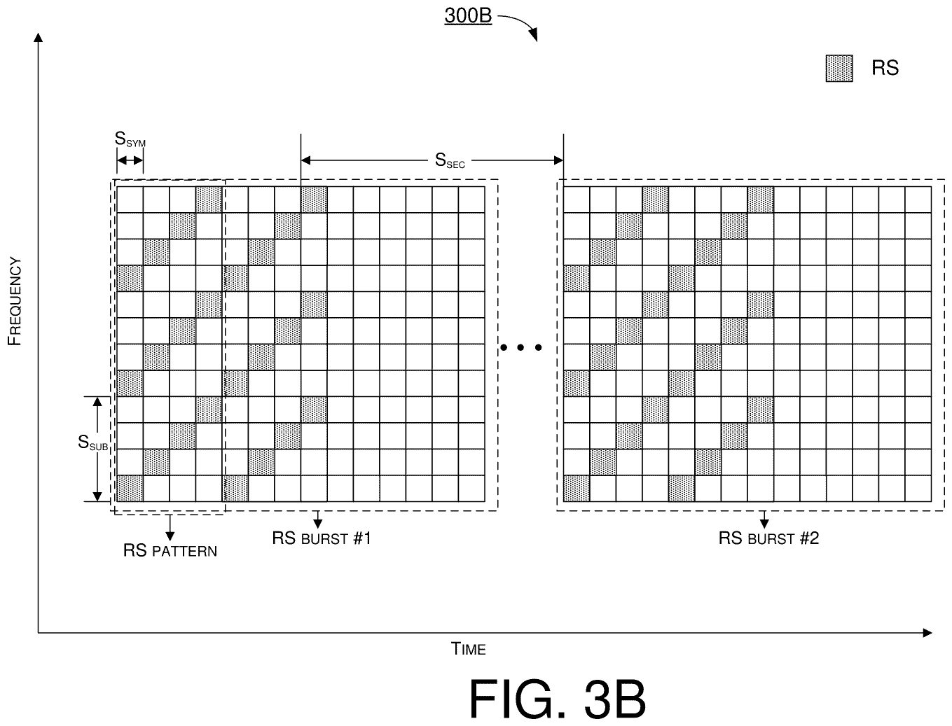

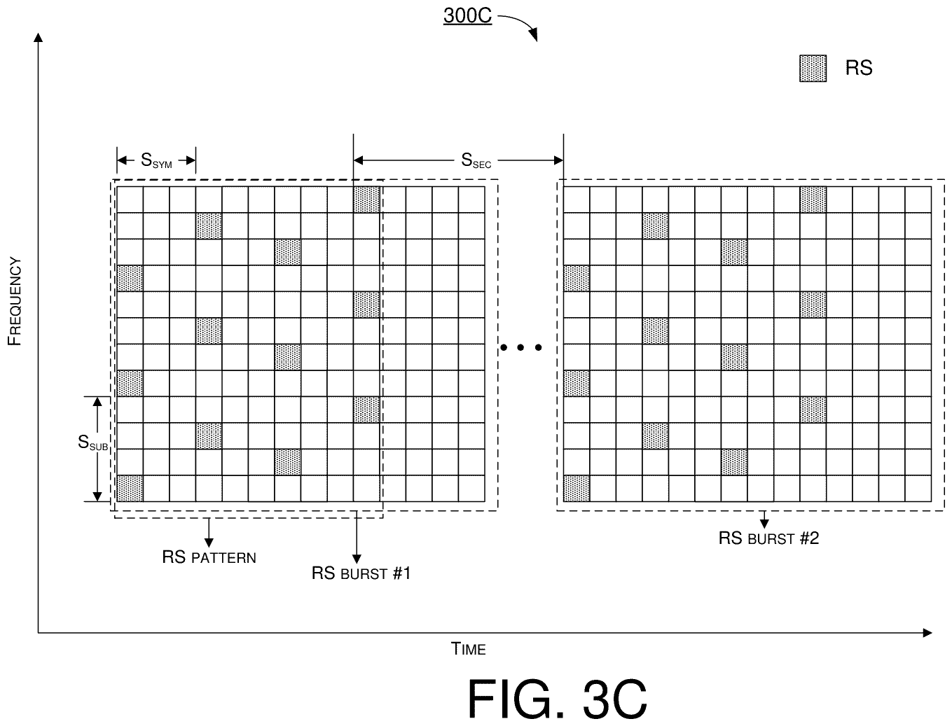

FIG. 3A illustrates an example scenario 300A under schemes in accordance with implementations of the present disclosure. For example, an RS burst in the time domain is shown in FIG. 3A when S_{sub} is 4, S_{sym} is 3, U_{F} is 1, N_{F} is 4, S_{sec} is ×1 (which is an integer equal to or greater than 1), Q is 2, and staggering offset

$${F}_{m}^{intra}$$

for the symbol is {0}.

FIG. 3B illustrates an example scenario 300B under schemes in accordance with implementations of the present disclosure. For example, an RS burst in the time domain is shown in FIG. 3B when S_{sub} is 4, S_{sym} is 1, U_{F} is 4, N_{F} is 2, pₛₗₒₚₑ is 1, β₁ is 0, S_{sec} is ×2 (which is an integer equal to or greater than 1), and Q is 2.

FIG. 3C illustrates an example scenario 300C under schemes in accordance with implementations of the present disclosure. For example, an RS burst in the time domain is shown in FIG. 3C when S_{sub} is 4, S_{sym} is 3, U_{F} is 4, N_{F} is 1, S_{sec} is ×3 (which is an integer equal to or greater than 1), and Q is 2, and staggering offsets

$${F}_{m}^{intra}$$

for the symbol are {0, 2, 1, 3}.

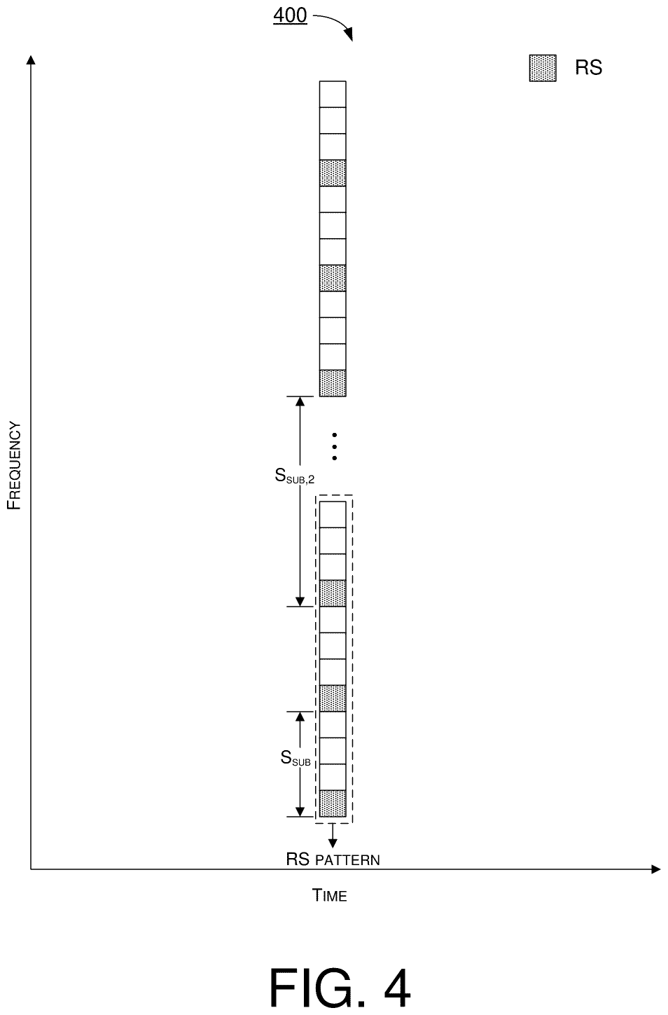

FIG. 4 illustrates an example scenario 400 under schemes in accordance with implementations of the present disclosure. For example, an RS burst in the frequency domain is shown in FIG. 4 when S_{sub} is 4, S_{sub,2} is a1, and U_{F} is 1.

In some implementations, parameter(s) may be associated with the third-level for defining the RS pattern set in the time domain or frequency domain. The parameter(s) may include at least one of: (1) an RS pattern set spacing S_{third} in the time domain (in unit of symbol), (2) an RE spacing S_{sub,3} between a first RE included in one RS burst and a second RE included in an adjacent RS burst in the frequency domain (in unit of RE), (3) a number of RS pattern sets P, and (4) an RS pattern set period T_{third}.

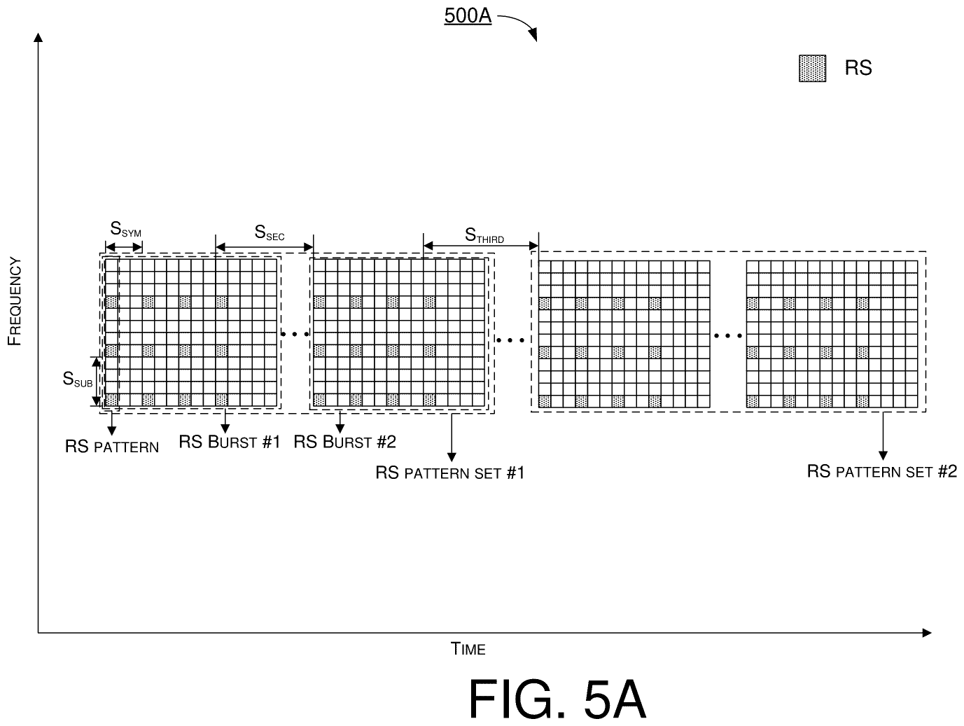

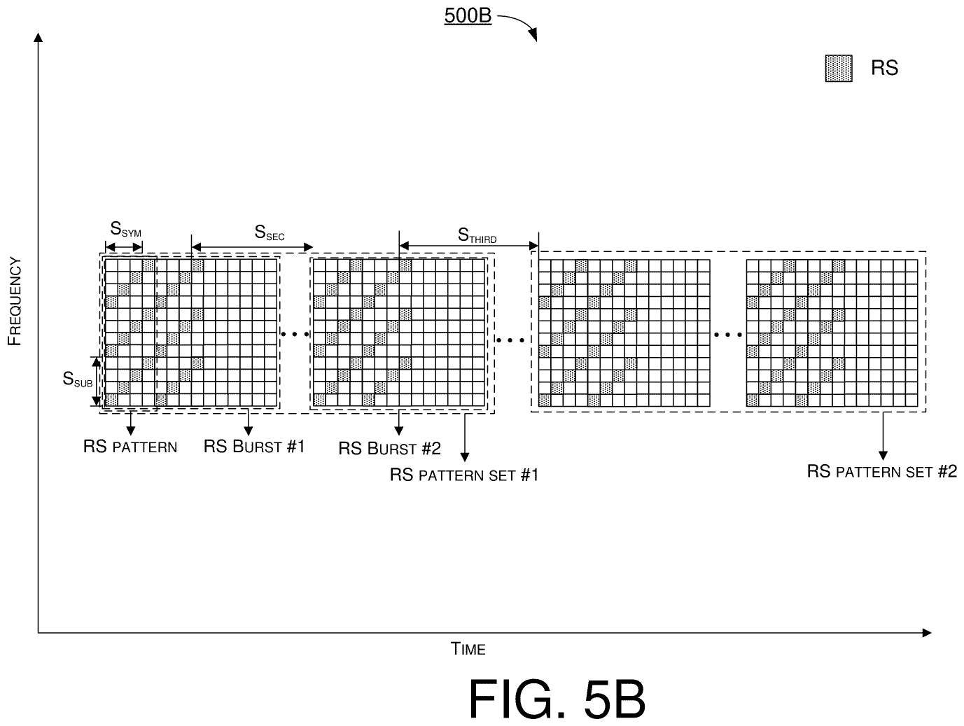

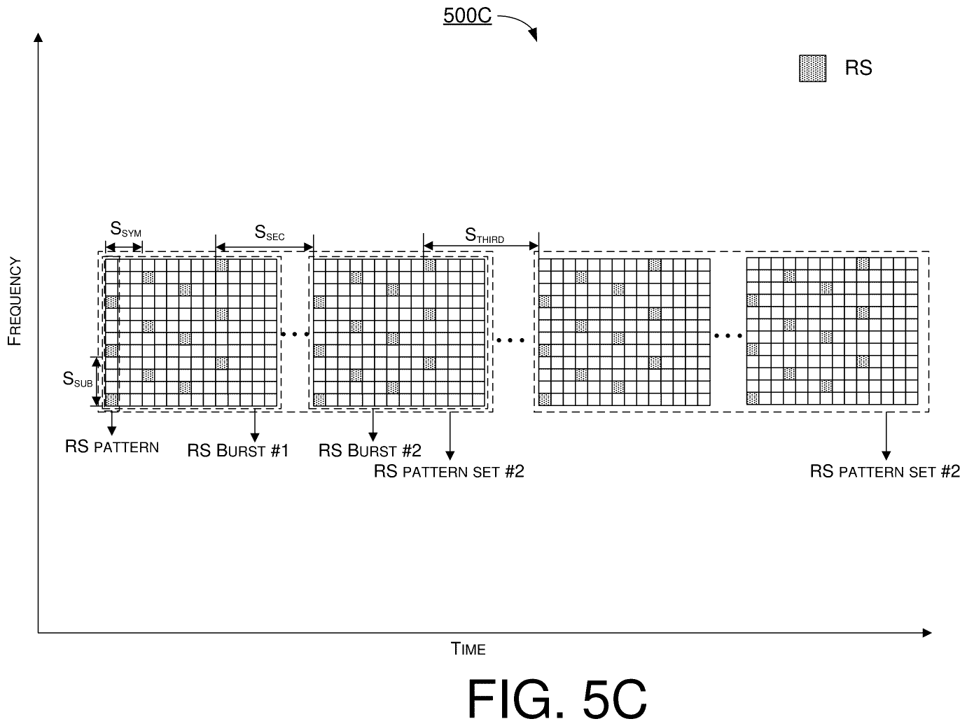

FIG. 5A illustrates an example scenario 500A under schemes in accordance with implementations of the present disclosure. For example, an RS pattern set in the time domain is shown in FIG. 5A when S_{sub} is 4, S_{sym} is 3, U_{F} is 1, N_{F} is 4, S_{sec} is y1, Q is 2, S_{third} is z1, P is 2, and staggering offset

$${F}_{m}^{intra}$$

for the symbol is {0}.

FIG. 5B illustrates an example scenario 500B under schemes in accordance with implementations of the present disclosure. For example, an RS pattern set in the time domain is shown in FIG. 5B when S_{sub} is 4, S_{sym} is 1, U_{F} is 4, N_{F} is 2, pₛₗₒₚₑ is 1, β₁ is 0, S_{sec} is y2, Q is 2, S_{third} is z2, and P is 2.

FIG. 5C illustrates an example scenario 500C under schemes in accordance with implementations of the present disclosure. For example, an RS pattern set in the time domain is shown in FIG. 5C when S_{sub} is 4, S_{sym} is 3, U_{F} is 4, N_{F} is 1, S_{sec} is y3, Q is 2, S_{third} is z3, and P is 2, and staggering offsets

$${F}_{m}^{intra}$$

for the symbol are {0, 2, 1, 3}.

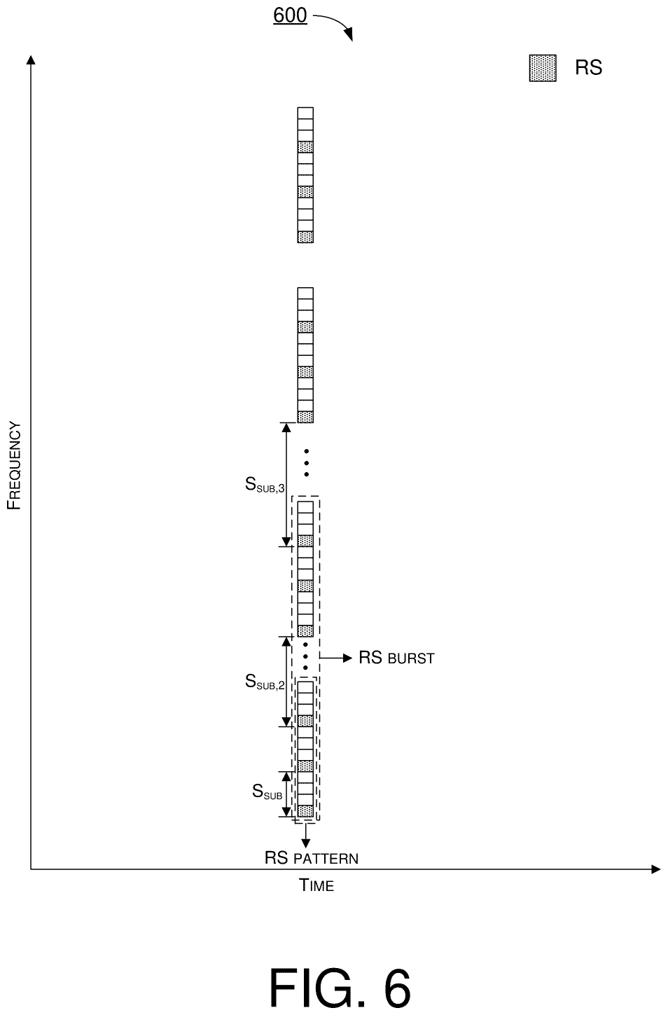

FIG. 6 illustrates an example scenario 600 under schemes in accordance with implementations of the present disclosure. For example, an RS pattern set in the frequency domain is shown in FIG. 6 when S_{sub} is 4, S_{sub,2} is a2, S_{sub,3} is b2, and U_{F} is 1.

It should be noted that, in the frequency domain, the three-level framework may degenerate to a two-level framework when there is a single RS pattern in each RS burst or S_{sub,3}=S_{sub,2}. In addition, three-level framework may degenerate to one-level framework when S_{sub,3}=S_{sub,2}=S_{sub,1}.

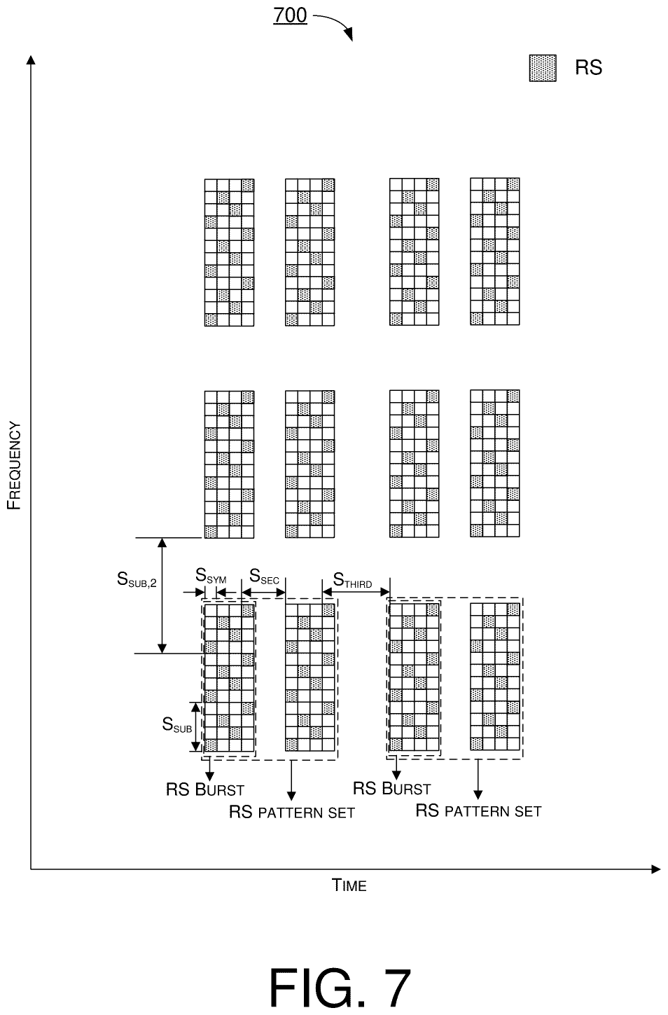

FIG. 7 illustrates an example scenario 700 under schemes in accordance with implementations of the present disclosure. For example, an RS pattern set in both the time domain and the frequency domain is shown in FIG. 7 when staggering offset

$${F}_{m}^{intra} = \{ 0213 \} ,$$

S_{sub} is 4, S_{sym} is 1, S_{sub,2} is 12, S_{sec} is 4, S_{third} is 10, and U_{F} is 4.

In some implementations, any two of the symbol spacing S_{sym}, the burst spacing S_{sec} and the RS pattern set spacing S_{third} may be arranged to achieve maximum Doppler unambiguous range. For example, any two of the symbol spacing S_{sym}, the burst spacing S_{sec} and the RS pattern set spacing S_{third} may be coprime.

Some analysis of the ambiguity characteristics in the delay-Doppler domain (i.e., distance-velocity domain) associated with different RS frameworks may be provided in the following paragraphs. The analysis may be based on super-resolution algorithms, such as Multiple Signal Classification (MUSIC) or Iterative Adaptive Approach (IAA).

Let τ and f are true delay and Doppler of a sensing target. In configurations utilizing a no-staggering RS pattern, the delay and Doppler domains are decoupled. Accordingly, the analysis focuses on the Doppler domain. Under this condition, the signal model solved by the MUSIC or IAA algorithm is as follows:

$$A = BS + Noise$$

where received vector is A, and amplitude vector of sensing signal is

$$S = {α}_{0} {e}^{j 2 π {f}_{h} T \{ p [ ( Q - 1 ) ( ( M - 1 ) {S}_{sym} + {S}_{sec} ) + ( M - 1 ) {S}_{sym} + {S}_{third} ] + q ( M - 1 ) {S}_{sym} + {S}_{sec}} ) + {mS}_{sym} \}$$

where q=0, 1, . . . , Q−1, m=0, 1, . . . , M−1, p=0, 1, . . . , P−1 denote the indexes of symbol, RS burst and RS pattern set, T is OFDM symbol duration. Steering vector B is estimated vector which is represented as:

$$[ \begin{matrix}{e}^{- j 2 π 0 \cdot {S}_{sym} {Tf}_{h}} \\ {e}^{- j 2 π 1 \cdot {S}_{sym} {Tf}_{h}} \\ ⋮ \\ {e}^{- j 2 π ( M - 1 ) \cdot {S}_{sym} {Tf}_{h}} \\ {e}^{- j 2 π {f}_{h} T \{ ( ( M - 1 ) {S}_{sym} + {S}_{sec} ) + 0 \cdot {S}_{sym} \}} \\ \\ ⋮ \\ {e}^{- j 2 π {f}_{h} T \{ p [ ( Q - 1 ) ( M - 1 ) {S}_{sym} + {S}_{sec} ) + ( M - 1 ) {S}_{sym} + {S}_{third} ] + q ( M - 1 ) {S}_{sym} + {S}_{sec} ) + {mS}_{sym} \}} \\ ⋮ \\ {e}^{- j 2 π {f}_{h} T \{ ( P - 1 ) [ ( Q - 1 ) ( ( M - 1 ) {S}_{sym} + {S}_{sec} ) + ( M - 1 ) {S}_{sym} + {S}_{third} ] + ( Q - 1 ) ( M - 1 ) {S}_{sym} + {S}_{sec} ) + ( M - 1 ) {S}_{sym} \}}\end{matrix} ]$$

To fulfill that no ambiguity peak exists, the anti-condition of equation

$$\begin{matrix}{e}^{j 2 π {f}_{h} T \{ p [ ( Q - 1 ) ( ( M - 1 ) {S}_{sym} + {S}_{sec} ) + ( M - 1 ) {S}_{sym} + {S}_{third} ] + q ( ( M - 1 ) {S}_{sym} + {S}_{sec} ) + {mS}_{sym} \}} \\ = {e}^{j 2 π ( {f}_{h} + Δ {f}_{h} ) T \{ p [ ( Q - 1 ) ( ( M - 1 ) {S}_{sym} + {S}_{sec} ) + ( M - 1 ) {S}_{sym} + {S}_{third}} ] + q ( ( M - 1 ) {S}_{sym} + {S}_{sec} ) + {mS}_{sym} \}\end{matrix}$$

should be met for each q, m and p. The conditions under which the previous formula is satisfied are first derived. Equivalently, the previous formula is reformulated as follows:

$$\begin{matrix}Δ {f}_{h} T \{ p [ ( Q - 1 ) ( ( M - 1 ) {S}_{sym} + {S}_{sec} ) + ( M - 1 ) {S}_{sym} + {S}_{third} ] + q ( ( M - 1 ) {S}_{sym} + {S}_{sec} ) + {mS}_{sym} \} \\ = Z , q = 0 , … , Q - 1 , m = 0 , … , M - 1 , p = 0 , … , P - 1\end{matrix}$$

Firstly, p=q=0,

$$Δ {f}_{h} = \frac{Z}{{TS}_{sym}} ,$$

Zϵ{1, 2, . . . , S_{sym}−1} satisfies the previous formula. Then substituting

$$Δ {f}_{h} = \frac{Z}{{TS}_{sym}}$$

into previous formula,

$$\begin{matrix}\frac{{ZpS}_{third}}{{S}_{sym}} + \frac{Z ( p ( Q - 1 ) + q ) {S}_{sec}}{{S}_{sym}} + \\ Z ( p ( Q - 1 ) ( M - 1 ) + ( p + q ) ( M - 1 ) + m ) = {Z}_{1} ,\end{matrix}$$

the third term in left side of previous formula is integer already, which is ignored in the following derivation. Let p=0,

$$\begin{matrix}\frac{{ZqS}_{sec}}{{S}_{sym}} ∈ \\ ℤ\end{matrix}$$

for each q, only when S_{sec} and S_{sym} are not coprime. Then set q=0,

$$\frac{Zp [ {S}_{third} + ( Q - 1 ) {S}_{sec} ]}{{S}_{sym}} .$$

If S_{sec} and S_{sym} are not coprime, set

$$\frac{{ZS}_{sec}}{{S}_{sym}} = {Z}_{2}$$

(Z₂ is an integer),

$$\begin{matrix}\frac{Z [ {S}_{third} + ( Q - 1 ) {S}_{sec} ]}{{S}_{sym}} = \\ \frac{{ZS}_{third}}{{S}_{sym}} + {Z}_{2} ( Q - 1 ) ∈ ℤ\end{matrix}$$

only when S_{third} and S_{sym} are not coprime. It is concluded that, in no-staggering RS pattern, there are two types of RS configuration cases:

First Case: any two of S_{third}, S_{sec} and S_{sym} are coprime, the maximum unambiguous range in the Doppler (velocity) domain is achieved.

Second Case: when S_{third}, S_{sec} and S_{sym} are not coprime, estimated targets at

$$Δ {f}_{h} = f + \frac{Z}{{TS}_{sym}} , Z = {ϕ}_{1} ⋂ {ϕ}_{2}$$

$$where$$

$$\begin{matrix}{Φ}_{1} = \{ z \vert 1 \leq \frac{lcm ( {S}_{third} , {S}_{sym} )}{{S}_{third}} \cdot z \leq {S}_{sym} - 1 , z is a integer \} \\ {Φ}_{2} = \{ z \vert 1 \leq \frac{lcm ( {S}_{sec} , {S}_{sym} )}{{S}_{sec}} \cdot z \leq {S}_{sym} - 1 , z is a integer \}\end{matrix}$$

where lcm(⋅) means least common multiple.

For staggering RS pattern, formula solved in MUSIC/IAA is as shown in A=BS+Noise. Amplitude vector S of sensing signal is:

$${α}_{0} {e}^{- j 2 πΔ f τ ( {kS}_{sub} + {F}_{m}^{intra} )} {e}^{j 2 π {f}_{h} T \{ p [ ( Q - 1 ) ( M - 1 ) {S}_{sym} + {S}_{sec} ) + ( M - 1 ) {S}_{sym} + {S}_{third} ] + q ( M - 1 ) {S}_{sym} + {S}_{sec} ) + {mS}_{sym} \}}$$

where k=0, 1, . . . , N−1, q=0, 1, . . . , Q−1, m=0, 1, . . . , M−1, p=0, 1, . . . , P−1. The estimated steering vector B is:

$$[ \begin{matrix}{e}^{- j 2 π Δ d τ ( 0 {S}_{sub} + {F}_{0}^{intra} )} {e}^{j 2 π 0 : {S}_{sym} {Tf}_{h}} \\ {e}^{- j 2 π Δ d τ ( 1 {S}_{sub} + {F}_{0}^{intra} )} {e}^{j 2 π 0 : {S}_{sym} {Tf}_{h}} \\ ⋮ \\ {e}^{- j 2 π Δ d τ ( {i}_{sub} {S}_{sub} + {F}_{0}^{intra} )} {e}^{j 2 π 0 : {S}_{sym} {Tf}_{h}} \\ \\ ⋮ \\ {e}^{- j 2 π Δ f τ ( {kS}_{sub} + {F}_{0}^{intra} )} {e}^{j 2 π {f}_{h} T \{ q ( ( M - 1 ) {S}_{sym} + {S}_{sec} ) + {mS}_{sym} \}} \\ ⋮ \\ {e}^{- j 2 πΔ f τ ( ( N - 1 ) {S}_{sub} + {F}_{m}^{intra} )} {e}^{j 2 π {f}_{h} {Te}^{j 2 π {f}_{h} T \{ ( P - 1 ) [ ( Q - 1 ) ( M - 1 ) {S}_{sym} + {S}_{sec} ) + ( M - 1 ) {S}_{sym} + {S}_{third} ] + ( Q - 1 ) ( M - 1 ) {S}_{sym} + {S}_{sec} ) + ( m - 1 ) {S}_{sym} \}}}\end{matrix} ]$$

To fulfill that no ambiguity peak exists, the anti-condition:

$$\begin{matrix}{e}^{- j 2 πΔ f τ ( {kS}_{sub} + {F}_{m}^{intra} )} {e}^{j 2 π {f}_{h} T \{ p [ ( Q - 1 ) ( ( M - 1 ) {S}_{sym} + {S}_{sec ) + ( M - 1 ) {S}_{sym} + {S}_{third} ] + q ( ( M - 1 ) {S}_{sym} + {S}_{sec} ) + {mS}_{sym} \}}} \\ = {e}^{- j 2 πΔ f ( τ + Δ τ ) ( {kS}_{sub} + {F}_{m}^{intra} )} {e}^{j 2 π ( {f}_{h} + Δ {f}_{h} ) T \{ p [ ( Q - 1 ) ( ( M - 1 ) {S}_{sym} + {S}_{sec} ) + ( M - 1 ) {S}_{sym} + {S}_{third} ] + q ( ( M - 1 ) {S}_{sym} + {S}_{sec} ) + {mS}_{sym} ) + {mS}_{sym} \}}\end{matrix}$$

should be met for each k, q, m and p. Equivalently, the previous formula is set as:

$$\begin{matrix}- Δ f Δτ ( {kS}_{sub} + {F}_{m}^{intra} ) + Δ {f}_{h} T \{ p [ Q - 1 ) ( ( M - 1 ) {S}_{sym} + {S}_{sec} ) + ( M - 1 ) {S}_{sym} + {S}_{third} \} \\ + q ( M - 1 ) {S}_{sym} + {S}_{sec} ) + {mS}_{sym} \} ∈ ℤ , ∀ m , q , p , k\end{matrix}$$

In the first step, let m=q=p=0, the previous formula is equivalent to

$$- Δ f Δτ ( {kS}_{sub} + {F}_{0}^{intra} ) = {Z}_{1} ,$$

then

$$Δτ = - \frac{{Z}_{1}}{Δ {fS}_{sub}} ,$$

Z₁ϵ{1, 2, . . . , S_{sub}−1}. Then substitute Δτ into previous equation,

$$\begin{matrix}\frac{{Z}_{1} {F}_{m}^{intra}}{{S}_{sub}} + Δ {f}_{h} T \{ {pS}_{third} + ( p ( Q - 1 ) + q ) {S}_{sec} \\ + ( p ( Q - 1 ) ( M - 1 ) + q ( M - 1 ) + p ( M - 1 ) + m ) {S}_{sym} \} = {Z}_{2}\end{matrix}$$

where Z₁k is ignored in the following derivation since it is integer already.

Secondly, let k=q=p=0 and m=1, ΔfₕTS_{sym}S_{sub}=Z₂, Z₂ϵ{1, 2, . . . , S_{sym}S_{sub}−1}, substituting

$$Δ {f}_{h} T = \frac{{Z}_{2}}{{S}_{sym} {S}_{sub}}$$

into the previous formula:

$$\frac{{Z}_{1} {F}_{m}^{i n t r a}}{{S}_{s u b}} + \frac{{Z}_{2}}{{S}_{s y m} {S}_{s u b}} \{ p {S}_{third} + ( p ( Q - 1 ) + q ) {S}_{s e c} + ( p ( Q - 1 ) ( M - 1 ) + q ( M - 1 ) + p ( M - 1 ) + m ) {S}_{s y m} \} ∈ ℤ$$

Thirdly, let m=p=0,

$$\frac{{Z}_{2} [ {S}_{s e c} + ( M - 1 ) {S}_{s y m} ] q}{{S}_{s y m} {S}_{s u b}} ∈ ℤ$$

(considering rotation invariance of MUSIC, it is reasonable to assume

$${F}_{0}^{intra} = 0 )$$

which is equivalent to that formula holds true when S_{sec}+(M−1)S_{sym} and S_{sym}S_{sub} are not coprime. Specially, if M=S_{sub} is assumed,

$$\frac{{Z}_{2} [ {S}_{s e c} + ( M - 1 ) {S}_{s y m} ] q}{{S}_{s y m} {S}_{s u b}} = {Z}_{3} ,$$

(Z₃ is an integer) is represented as Z₂(S_{sec}−S_{sym})=Z₃S_{sym}S_{sub}, i.e., (S_{sec}−S_{sym}) and S_{sym}S_{sub} are not coprime.

Fourthly, let m=q=0, the previous formula is represented as:

$${Z}_{2} p \{ {s}_{third} + ( Q - 1 ) ( ( {S}_{s e c} - {S}_{s y m} ) ) \} = {Z}_{3} {S}_{s y m} {S}_{s u b}$$

and equation holds true when {S_{third}+(Q−1)((S_{sec}−S_{sym}))} and S_{sym} and S_{sub} are not coprime. Then let

$$p = q = 0 , \frac{{Z}_{1} {F}_{m}^{i n t r a}}{{S}_{s u b}} + \frac{{Z}_{2} m}{{S}_{s u b}} ∈ ℤ ,$$

which is equivalent

$$mod \{ {Z}_{1} {F}_{m}^{intra} + {Z}_{2} m , {S}_{s u b} \} = 0.$$

For general staggering RS patterns, anti-condition of the previous formula is equivalent to anti-condition of the following equations.

$$\{ \begin{matrix}mod \{ {Z}_{2} ( {S}_{s e c} + ( M - 1 ) {S}_{s y m} ) , {S}_{s y m} {S}_{s u b} \} = 0 \\ and / or mod \{ {Z}_{2} \{ {S}_{third} + ( Q - 1 ) ( {S}_{s e c} + ( M - 1 ) {S}_{s y m} ) \} , {S}_{s y m} {S}_{s u b} \} = 0 \\ and mod \{ {Z}_{1} {F}_{m}^{intra} + {Z}_{2} m , {S}_{s u b} \} = 0\end{matrix}$$

When the first level RS framework includes one or more complete RS patters, which means mod (M, S_{sub})=0, anti-condition of the previous formula is equivalent to anti-condition of the following equations.

$$\{ \begin{matrix}mod \{ {Z}_{2} ( {S}_{s e c} - {S}_{s y m} ) , {S}_{s y m} {S}_{s u b} \} = 0 \\ and / or mod \{ {Z}_{2} \{ {S}_{third} + ( Q - 1 ) ( ( {S}_{s e c} - {S}_{s y m} ) ) \} , {S}_{s y m} {S}_{s u b} \} = 0 \\ and mod \{ {Z}_{1} {F}_{m}^{intra} + {Z}_{2} m , {S}_{s u b} \} = 0\end{matrix}$$

It should be noted that one example to holds mod {Z₂(S_{sec}−S_{sym}), S_{sym}S_{sub}}≠0 is S_{sec} and S_{sym} are coprime, which indicates S_{sec}−S_{sym} and S_{sub} are coprime.

Next, based on the using entire RS pattern in the first level RS framework, the unambiguous range of delay-doppler is analyzed.

For staggering A RS pattern, in mathematical derivation,

$${F}_{m}^{intra}$$

is equivalent to

$${F}_{m}^{intra} = {p}_{s l o p e} \cdot m .$$

In some cases, estimated targets at Δfₕ=f, Δτ=τ, which means unambiguous range of delay-doppler is maximum, when following conditions are satisfied:

$$\{ \begin{matrix}mod \{ {Z}_{2} ( {S}_{s e c} - {S}_{s y m} ) , {S}_{s y m} {S}_{s u b} \} \neq 0 \\ and / or mod \{ {Z}_{2} \{ {S}_{third} + ( Q - 1 ) ( ( {S}_{s e c} - {S}_{s y m} ) ) \} , {S}_{s y m} {S}_{s u b} \} \neq 0 \\ and mod \{ {Z}_{1} {p}_{s l o p e} + {Z}_{2} , {S}_{s u b} \} \neq 0\end{matrix}$$

In some cases, estimated targets at

$$Δ {f}_{h} = f + \frac{{Z}_{2}}{T {S}_{s y m}} - \frac{{Z}_{1} {p}_{s l o p e}}{{TS}_{s y m} {S}_{s u b}} , Δτ = τ - \frac{{Z}_{1}}{Δ {fS}_{sub}} ,$$

when following equations establish:

$$\{ \begin{matrix}mod \{ {Z}_{2} ( {S}_{s e c} - {S}_{s y m} ) , {S}_{s y m} {S}_{s u b} \} = 0 \\ mod \{ {Z}_{2} \{ {S}_{third} + ( Q - 1 ) ( ( {S}_{s e c} - {S}_{s y m} ) ) \} , {S}_{s y m} {S}_{s u b} \} = 0 \\ and mod \{ {Z}_{1} {p}_{s l o p e} + {Z}_{2} , {S}_{s u b} \} = 0\end{matrix}$$

where integer 0≤Z₂≤S_{sym}−1, 0≤Z₁≤S_{sub}−1, which can be directly obtained through the previous formulas.

In some cases, estimated targets at

$$Δ {f}_{h} = f + \frac{{Z}_{2}}{T {S}_{s y m}} ,$$

Δτ=τ, when

$$\{ \begin{matrix}mod \{ {Z}_{2} ( {S}_{sec} - {S}_{sym} ) , {S}_{sym} {S}_{sub} \} = 0 \\ and / or mod \{ {Z}_{2} \{ {S}_{third} + ( Q - 1 ) ( ( {S}_{sec} - {S}_{sym} ) ) \} , {S}_{sym} {S}_{sub} \} = 0 \\ and mod \{ {Z}_{1} {p}_{slope} + {Z}_{2} , {S}_{sub} \} \neq 0\end{matrix}$$

For staggering B RS pattern, staggering offset

$${F}_{m}^{intra}$$

of which fulfills the formula

$$mod \{ {Z}_{1} {F}_{m}^{intra} + {Z}_{2} m , {S}_{sub} \} \neq 0$$

for each m, which indicates that no ambiguity peak exists in delay domain. Then let Z₁=0, the analyzed equation is degenerated into the previous formula, hence the derivation logic is the same as no-staggering pattern.

In some cases, estimated targets at Δfₕ=f, Δτ=τ, which means the unambiguous range of delay-doppler is maximum, when the following conditions are satisfied: any two of S_{third}, S_{sec} and S_{sym} are coprime.

In some cases, when S_{third}, S_{sec} and S_{sym} are not coprime, estimated targets at

$$Δ {f}_{h} = f + \frac{Z}{T {S}_{s y m}} ,$$

Δτ=τ, Z=Φ₁∩Φ₂:

where

$${Φ}_{1} = \{ z \vert 1 \leq \frac{l c m ( {S}_{third} , {S}_{s y m} )}{{S}_{third}} \cdot z \leq {S}_{s y m} - 1 , z is a integer \}$$

$${Φ}_{2} = \{ z \vert 1 \leq \frac{l c m ( {S}_{sec} , {S}_{s y m} )}{{S}_{sec}} \cdot z \leq {S}_{s y m} - 1 , z is a integer \}$$

where lcm(⋅) means least common multiple, Z≤S_{sym}−1, is an integer.

In the three level RS framework, when the spacing S_{third}, S_{sec} and S_{sym} levels are equal, the RS framework simplifies to a single-level configuration. This configuration is suitable for use cases that require a uniform RS configuration scheme, such as respiration detection, intrusion detection, etc.

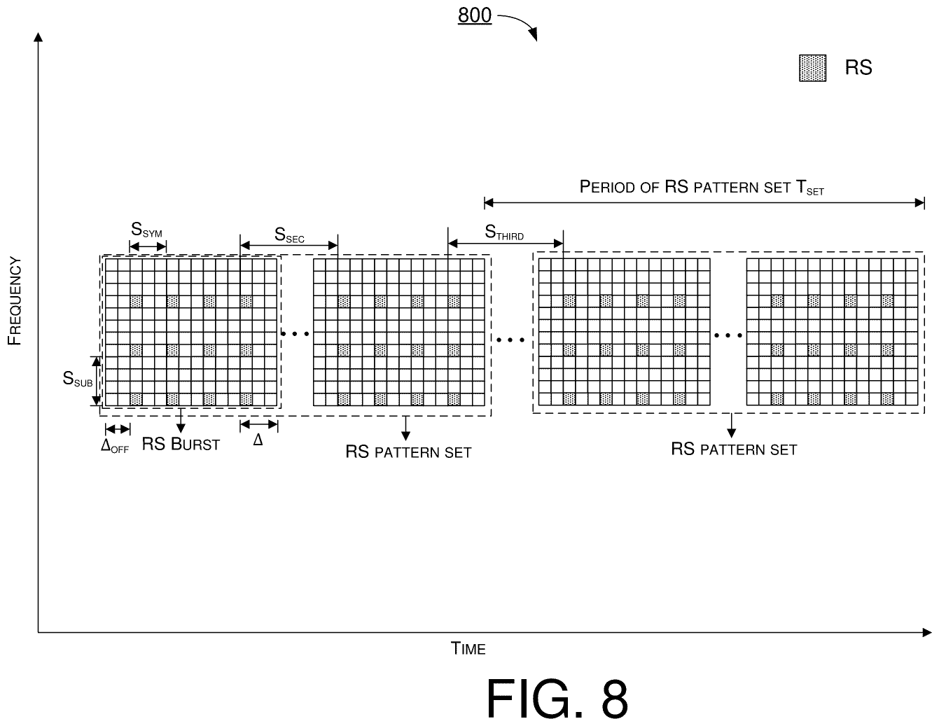

The three level RS configuration framework, if to be applied in traditional slot-based communication systems, may adopt the following schemes: for instance, ensuring that the length of the RS pattern and burst is less than or equal to the length of a slot, and ensuring that the position of the RS pattern and burst is within a single slot, where the concept of a burst can be equated to that of a slot. Under these conditions, the following equation holds:

$$( M - 1 ) {S}_{sym} + {Δ}_{off} + Δ = 14$$

where Δ_{off} is starting symbol offset, Δ is symbol spacing between the last RS symbol in an RS burst and the 14^{th} symbol of the slot, referring to FIG. 8 which is a schematic diagram of three level RS framework for slot-based system with no-staggering RS pattern, where RS pattern is no-staggering pattern, M=4 Δ_{off}=2, S_{sym}=3, Δ=3, S_{sec}=Δ+Δ_{off}=5.

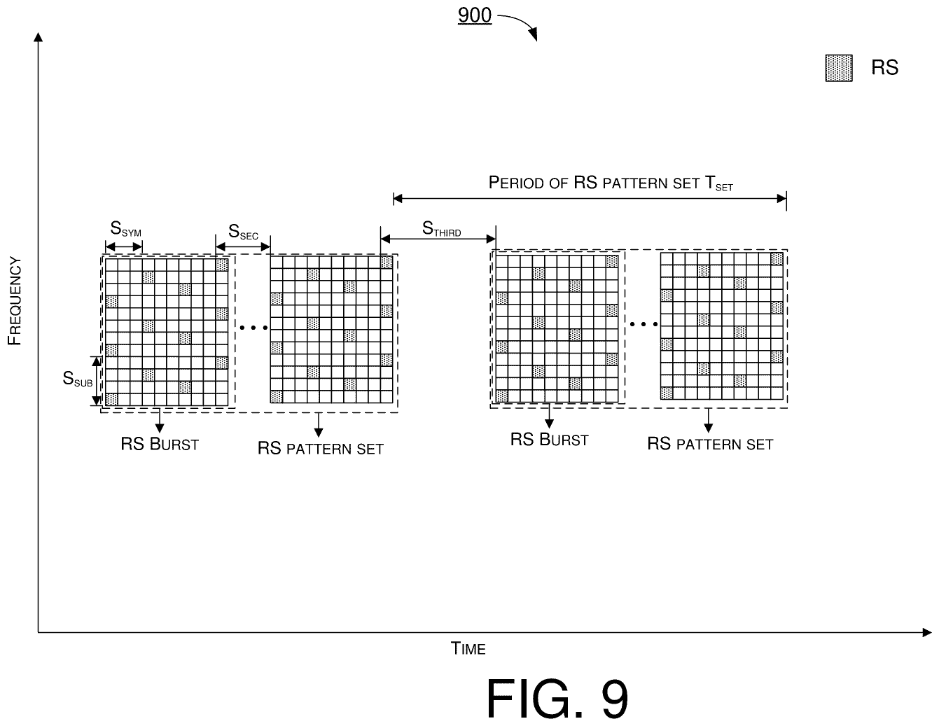

For symbol-based communication systems, the three layer RS framework may be directly applied. The length of the RS pattern and RS burst may be less than or equal to, or greater than, a slot. The position of the RS pattern and RS burst may also cross the boundary of a slot, as shown in FIG. 9 which is a schematic diagram of three three-level RS framework for a symbol-based system with a staggering B RS pattern, where the RS pattern is a staggering B pattern, the staggering offset

$${F}_{m}^{intra} = \{ 0 , 2 , 1 , 3 \} ,$$

N_{F}=1 M=4, S_{sym}=3.

To achieve the configurations mentioned in previous cases, where any two of S_{third}, S_{sec} and S_{sym} are relatively prime, and S_{sec} and S_{sym} are coprime, the following cases should be adopted:

In some cases, let S_{sym} and S_{sec} to be coprime, with no specific configuration requirements for S_{third}, allowing the RS pattern set to be transmitted with a period T_{third}.

In some cases, for the slot-based system, firstly, when the slot spacing of the adjacent RS burst Qₛₗₒₜ is zero, traverse through different values of M within an RS burst (a slot), and for varying values of starting symbol offset Δ_{off} within an RS burst (slot), identify all coprime pairs

$$( {S}_{sym}^{′} , {S}_{sec}^{′} ) ,$$

for example:
(1) Δ_{off}=0, M=2, coprime pairs

$$( {S}_{sym}^{′} , {S}_{sec}^{′} )$$

are (1,13), (3,11), (5,9), (9,5), (11,3), (13,1);
(2) Δ_{off}=0, M=4, coprime pairs

$$( {S}_{sym}^{′} , {S}_{sec}^{′} )$$

are (1, 12), (3,8), (5,4), (7,1).

In some cases, when the slot spacing of the adjacent RS burst is Qₛₗₒₜ≠0, to ensure that S_{sym} and S_{sec} are coprime, let Qₛₗₒₜ=z·S_{sym}, and

$${S}_{sym} = {S}_{sym}^{′} , {S}_{sec} = {Q}_{slot} \cdot 14 + {S}_{sec}^{′} ,$$

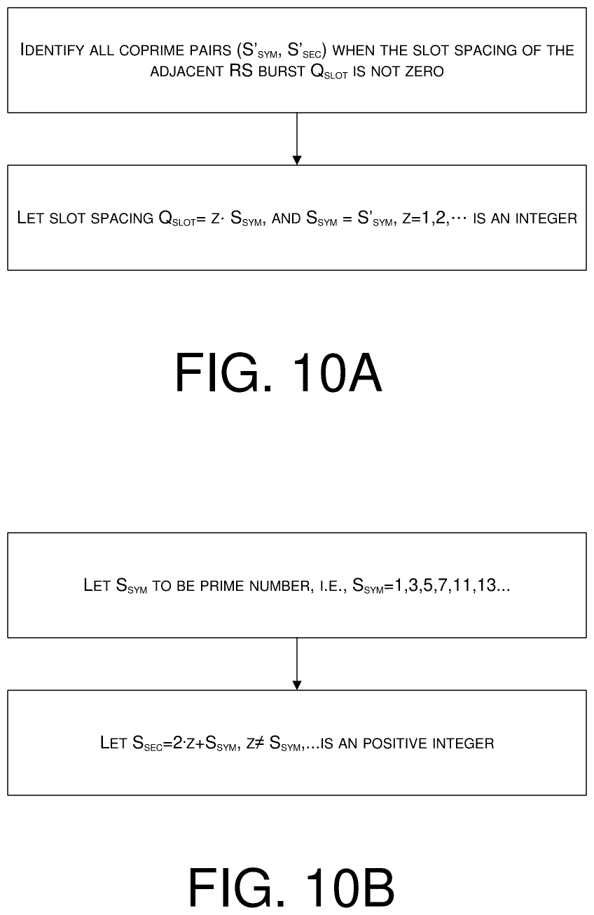

z=1, 2, . . . is integer, refer to FIG. 10A, which is a schematic diagram of a specific configuration method for a slot-based system to achieve maximum Doppler unambiguous range for a no-staggering pattern and maximum delay-Doppler unambiguous range for a staggering B pattern.

In some cases, for the symbol-based system, S_{sym} is set as a prime number, i.e. S_{sym}=1, 3, 5, 7, 11, 13, . . . , z≠S_{sym}, . . . is a positive integer, refer to FIG. 10B, which is a schematic diagram of a specific configuration method for the symbol-based system to achieve maximum Doppler unambiguous range for no-staggering pattern and maximum delay-Doppler unambiguous range for a staggering B pattern.

In some implementations, the RE spacings S_{sub}, S_{sub,2} and S_{sub,3} may have a common factor greater than 1.

For example, a multiple-level RS framework with staggering B RS pattern achieve maximum delay unambiguous range with super-resolution algorithms MUSIC or IAA algorithm, especially S_{sub,3}, S_{sub,2} and S_{sub,1} have a common factor greater than 1, where the definition of staggering B RS pattern is: staggering offset such that there does not exist an integer pair (κ₁ϵ{1, 2, . . . , S_{sub,1}−1}, κ₂ϵ [symbol] ) such that the following modulo equation system holds true:

$$mod ( i {𝒦}_{2} - ( {F}_{i} - {F}_{0} ) {𝒦}_{1} , {S}_{sub , 1} ) = 0 ,$$

$$for i = 0 , 1 , … {U}_{F} - 1 , {F}_{i} = {F}_{mod ( i , {U}_{F} )}$$

where U_{F} is number of symbols in one RS pattern.

Assuming a single target characterized by delay τ and doppler f_{D}, and regular RS pattern in time domain, the equation solved in MUSIC/IAA is:

$$A = BS + Noise$$

where received vector is A, and amplitude vector of sensing signal S,

$$S = vec \{ {e}^{j 2 π \{ Ψ + {F}_{i} \} Δ f τ} {e}^{- j 2 π {f}_{h} T 0} , {e}^{j 2 π \{ Ψ + {F}_{i} \} Δ f τ} {e}^{- j 2 π {f}_{h} T 1} , … , {e}^{j 2 π \{ Ψ + {F}_{i} \} Δ f τ} {e}^{- j 2 π {f}_{h} T ( I - 1 )}$$

where Δf denotes subcarrier spacing, ψ={qS_{sub,3}+[p+q(P−1)]S_{sub,2}+[m+p(M−1)+qP(M−1)]S_{sub,1}} denotes RE index which is column vector used by sensing RS, mϵ{0, . . . , M−1}, pϵ{0, . . . , p−1}, qϵ{0, . . . , Q−1} denote the indexes of RE within the first level, RB within the second level and RB burst set respectively, i=0, 1, . . . , (I−1), vec{⋅} denotes vectorization. The ith column of steering matrix B is estimated vector which is represented as

$$B = [ \begin{matrix}{e}^{- j 2 π ( 0 \cdot {S}_{sub , 1} + {F}_{i} ) Δ f τ} {e}^{j 2 π {f}_{h} Ti} \\ {e}^{- j 2 π ( 1 \cdot {S}_{sub , 1} + {F}_{i} ) Δ f τ} {e}^{j 2 π {f}_{h} Ti} \\ ⋮ \\ {e}^{- j 2 π [ ( M - 1 ) \cdot {S}_{sub , 1} + {F}_{i} ) Δ f τ} {e}^{j 2 π {f}_{h} Ti} \\ ⋮ \\ {e}^{- j 2 π Δ f τ \{ {qS}_{sub , 3} + [ p + q ( P - 1 ) ] {S}_{sub , 2} + [ m + p ( M - 1 ) + qP ( M - 1 ) ] {S}_{sub , 1} + {F}_{i} \}} {e}^{j 2 π {f}_{h} {Ti}^{}} \\ ⋮ \\ {e}^{- j 2 π Δ f τ \{ ( Q - 1 ) {S}_{sub , 3} + Q ( P - 1 ) {S}_{sub , 2} + QP ( M - 1 ) + {F}_{i} \}} {e}^{j 2 π {f}_{h} {Ti}^{}}\end{matrix} ]$$

To fulfill that no ambiguity peak exists, firstly analyze the anti-condition of equation:

$${e}^{- j 2 π Δ f τ \{ Ψ + {F}_{i} \}} {e}^{j 2 π {f}_{h} T i} = {e}^{- j 2 π Δ f ( τ + Δ τ ) \{ Ψ + {F}_{i} \}} {e}^{j 2 π ( {f}_{h} + Δ {f}_{h} ) T i}$$

should be met for each q, m, p and i.

Equivalently, the previous formula is reformulated as:

$$- Δ f Δ τ \{ Ψ + {F}_{i} \} + Δ {f}_{h} T i ∈ ℤ$$

for each q, m, p and i, where [symbol] denotes integer. Since MUSIC is invariant to constant phase rotation, F₀ is assumed as 0 reasonably.

Firstly let q=p=i=0,

$$- Δ f Δ τ {S}_{sub , 1} m = {κ}_{1}^{′} , {κ}_{1}^{′} = 0 , 1 , … , {S}_{s u b , 1} - 1 ,$$

which yields

$$Δ τ = \frac{{κ}_{1}^{′}}{Δ f {S}_{sub , 1}}$$

Then substituting Δτ into −ΔfΔτ{S_{sub,1}m+Fᵢ}+ΔfₕTi, which yields

$$Δ {f}_{h} T i - \frac{{κ}_{1}^{′} {F}_{i}}{{S}_{sub , 1}}$$

is integer, and this also implies that if ambiguous peaks need to be avoided, the equation

$$Δ {f}_{h} T i - \frac{{κ}_{1}^{′} {F}_{i}}{{S}_{sub , 1}}$$

should not result in an integer which is the definition of staggering B RS pattern.

Secondly, let q·0, p·0. Substitute

$$Δ τ = \frac{{κ}_{1}^{′}}{Δ f {S}_{sub , 1}}$$

into previous formula to obtain,

$$Δ {f}_{h} T i - \frac{{κ}_{1}^{′} \{ {F}_{i} + q {S}_{s u b , 3} + [ p + q ( P - 1 ) ] {S}_{s u b , 2} \}}{{S}_{s ub , 1}} ∈ ℤ$$

Since S_{sub,3}, S_{sub,2} and S_{sub,1} have common factor Γ, they are rewritten as S_{sub,1}=ΓZ₁, S_{sub,2}=ΓZ₂, S_{sub,3}=ΓZ₃, where Z₁, Z₂ and Z₃ is integer. Then

$$\frac{{κ}_{1}^{′} \{ q {S}_{sub , 3} + [ p + q ( P - 1 ) ] {S}_{s u b , 2} \}}{{S}_{sub , 1}}$$

is rewritten as

$$\frac{{κ}_{1}^{′} \{ q {Z}_{2} + [ p + q ( P - 1 ) ] {Z}_{3} \}}{{Z}_{1}}$$

for each q, p, which yields that is rewritten as the previous formula is satisfied when

$${κ}_{1}^{′} = {Z}_{1} {Γκ}_{1} ,$$

κ₁ϵ{0, 1, . . . , S_{sub,1}−1}, and at this time

$$\frac{{κ}_{1}^{′} \{ q {Z}_{2} + [ p + q ( P - 1 ) ] {Z}_{3} \}}{{Z}_{1}}$$

is integer too. According to definition of staggering B RS pattern

$$Δ {f}_{h} T i - \frac{{κ}_{1}^{′} {F}_{i}}{{S}_{sub , 1}}$$

is not integer, therefore, it is concluded that when S_{sub,3}, S_{sub,2} and S_{sub,1} have a common factor greater than 1, a three-level RS framework employing a staggering B RS pattern achieve the maximum unambiguous range in the delay domain.

In some implementations, before transmitting the plurality of RSs based on the RS pattern, the transmitter may extend Cyclic Prefix (CP). In particular, the transmitter may apply an Inverse Fast Fourier Transform (IFFT) to each symbol of the plurality of RSs to obtain a plurality of time domain RSs. Each time domain RS may include a plurality of segments. Each segment may be associated with at least one other segment; in other words, each segment may be derived by at least one other segment. Then, the transmitter may combine one or more segments of the plurality of segments with a CP to obtain an extended CP in each time domain RS. After obtaining the extended CP in each time domain RS, the transmitter may transmit the plurality of time domain RSs with the extended CPs.

After receiving the plurality of time domain RSs, the receiver may remove the extended CP from each time domain RS to obtain one or more first segments in each time domain RS. Then, the receiver may determine one or more second segments based on the one or more first segments in each time domain RS. The receiver may apply an FFT to each time domain RS including the one or more second segments and the one or more first segments to obtain the plurality of RSs.

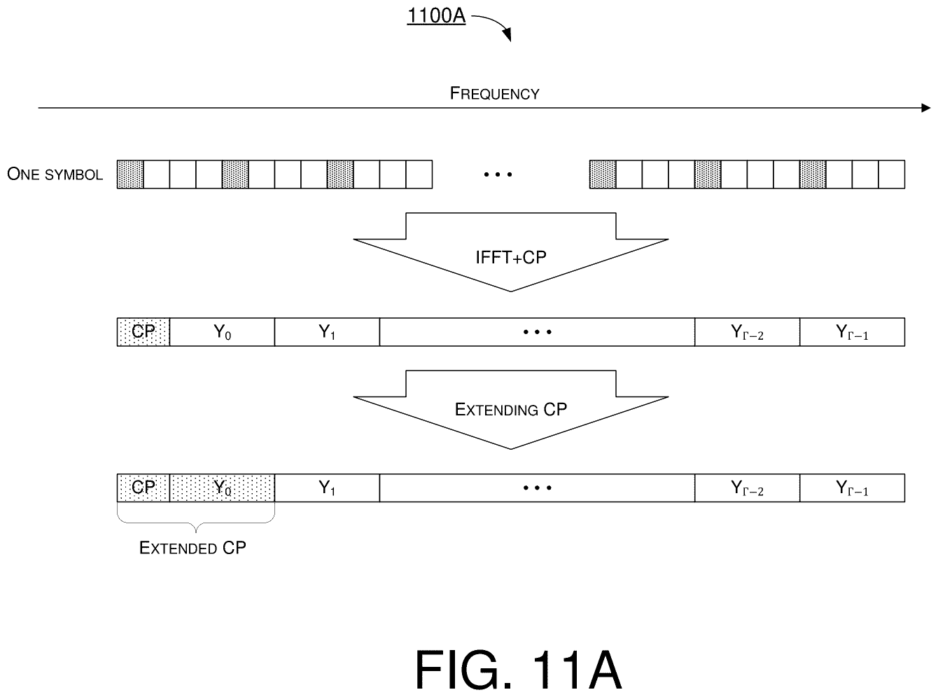

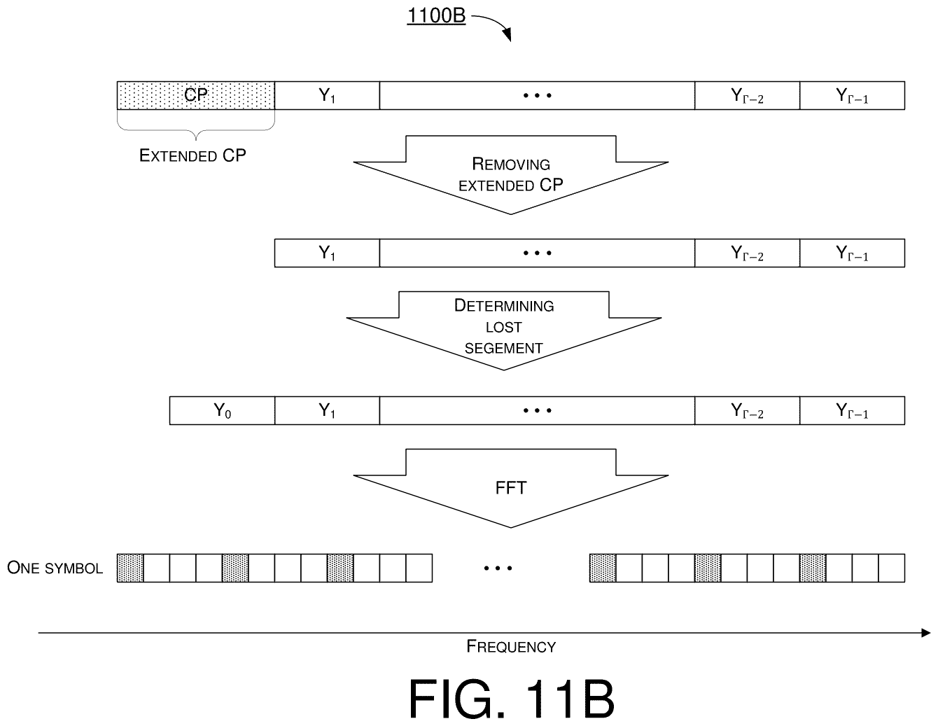

FIG. 11A illustrates an example scenario 1100A under schemes in accordance with implementations of the present disclosure. For example, before transmitting the plurality of RSs based on the RS pattern, the transmitter applies an IFFT to each symbol of the plurality of RSs to obtain a plurality of time domain RSs. Each time domain RS includes a plurality of segments Y, to Yr-1. Each segment is associated with at least one other segment based on the following formula:

$${Y}_{h} = {Y}_{0} {e}^{j \frac{2 π {F}_{i} h}{Γ}}$$

where Fᵢ is the staggering offset for ith symbol. Then, the transmitter combines segment Y₀ of the plurality of segments with a CP to obtain an extended CP in each time domain RS. After obtaining the extended CP in each time domain RS, the transmitter transmits the plurality of time domain RSs with the extended CPs.

FIG. 11B illustrates an example scenario 1100B under schemes in accordance with implementations of the present disclosure. After receiving the plurality of time domain RSs, the receiver removes the extended CP from each time domain RS to obtain segments Y₁ to Y_{Γ-1} in each time domain RS. Then, the receiver determines lost segment Y₀ based on any of segments Y₁ to Y_{Γ-1} in each time domain RS based on the previous formula. The receiver applies an FFT to each time domain RS including segments Y₀ to Y_{Γ-1} to obtain the plurality of RSs.

More specifically, CP length configured for communication may be determined based on a one-way propagation distance, which may be insufficient for sensing applications and may result in inter-symbol interference (ISI) at the sensing target, thereby degrading sensing accuracy and performance. Accordingly, the extended CP with multiple-level RS framework in frequency domain may be used.

In time domain, let Tₛ denotes OFDM symbol duration and T_{CP} denotes CP duration. T=T_{CP}+Tₛ represents symbol duration with CP-added. In frequency domain, a multi-level RS framework may be utilized. In this example three-level RS framework is taken as an example. S_{sub,1}, S_{sub,2} and S_{sub,3} may be the spacings for first level, second level and third level respectively, which have a common factor greater than 1. mϵ{0, . . . , M−1}, p={0, . . . , p−1}, q E {0, . . . , Q−1} are indexes for the first level, the second level and the third level. Xᵢ denotes the data sequence for the ith symbol in frequency domain. Further, data sequence of the ith symbol in time domain after IFFT is Yᵢ

$${Y}_{i} ( n ) = \frac{1}{{N}_{total}} {\sum }_{k = 0}^{{N}_{t o tal} - 1} {X}_{i} ( Ψ + {F}_{i} ) {e}^{j 2 π \frac{k n}{{N}_{t o t a l}}}$$

where Nₜₒₜₐₗ=(Q−1) S_{sub,3}+Q(P−1) S_{sub,2}+QP(M−1)S_{sub,1}+1 denotes total RE numbers occupied by Xᵢ, which is represented as:

$${Y}_{i} ( n ) = \frac{1}{{N}_{total}} {\sum }_{q = 0}^{Q - 1} {\sum }_{p = 0}^{P - 1} {\sum }_{m = 0}^{M - 1} {X}_{i} ( Ψ + {F}_{i} ) {e}^{j 2 π \frac{\{ Ψ + {F}_{i} \} n}{{N}_{t o t a l}}}$$

where ψ={qS_{sub,3}+[p+q(P−1)]S_{sub,2}+[m+p(M−1)+qP(M−1)]S_{sub,1}} is RE index, Fᵢ is staggering offset of each symbol. Let common factor of S_{sub,1}, S_{sub,2} and S_{sub,3} as Γ>1. Then Yᵢ is divided into Γ parts,

$${Y}_{i}^{h} = \{ {Y}_{i} ( n ) \} ,$$

nϵ{(h−1)L,hL},h=0, 1, . . . , Γ−1 length of each part is

$$L = \frac{{N}_{t o t a l}}{Γ} ,$$

$${Y}_{i}^{h} ( n ) = \frac{1}{{N}_{total}} {\sum }_{q = 0}^{Q - 1} {\sum }_{p = 0}^{P - 1} {\sum }_{m = 0}^{M - 1} {X}_{i} ( Ψ + {F}_{i} ) {e}^{j 2 π \frac{\{ Ψ + {F}_{i} \} n}{{N}_{t o t a l}}} {e}^{j 2 π \frac{\{ Ψ + {F}_{i} \} h L}{{N}_{t o t a l}}}$$

where

$${e}^{j 2 π \frac{\{ Ψ + {F}_{i} \} h L}{{N}_{total}}} = {e}^{j 2 π \frac{\{ Ψ \} h L}{{N}_{total}}} \cdot {e}^{j 2 π \frac{{F}_{i} h L}{{N}_{total}}} , {e}^{j 2 π \frac{\{ Ψ \} h L}{{N}_{total}}} = 1.$$

### Therefore,

$${Y}_{i}^{h} = {Y}_{i} {e}^{j 2 π \frac{{F}_{i} h L}{{N}_{total}}} ,$$

only phase rotation between different

$${Y}_{i}^{h}$$

and Yᵢ. It should be noted that Γ=S_{sub,1} when multi-level frequency domain framework degenerates to single-level frequency domain framework, i.e., S_{sub,1}=S_{sub,2}=S_{sub,3}.

Then, CP is added into time domain sequence Yᵢ, data sequence of the ith symbol added CP is set as

$$Z ( n ) = \frac{1}{{N}_{t o t a l}} {\sum }_{q = 0}^{Q - 1} {\sum }_{p = 0}^{P - 1} {\sum }_{m = 0}^{M - 1} {X}_{i} ( Ψ + {F}_{i} ) {e}^{j 2 π \frac{\{ Ψ + {F}_{i} \} ( {N}_{total} - {N}_{C P} + n )}{{N}_{total}}} ,$$

n=0, 1, . . . , Nₜₒₜₐₗ−N_{CP}−1. Passing through the channel, the sequence experiences time delay N_{τ} and Doppler frequency shift f_{D}. The data that reaches the sensing receiver is represented as

$$G ( {m}^{′} ) = Z ( n - {N}_{τ} ) {e}^{j 2 π {f}_{D} i T {S}_{s y m}}$$

At the sensing receiver, some data are treated as part of the extended CP and are removed along with CP before FFT, to expand the range without ISI, where extended CP includes first N_{CP}+hL part, h=0, 1, . . . , Γ−1. Next, by applying phase compensation to the remaining data sequence, the complete data Xᵢ from the transmitter is obtained through FFT.

Firstly, after removing the extended CP, the left data sequence is represented as:

$$G ( {m}^{′} ) = Z ( {N}_{C P} + h L + {m}^{′} - {N}_{τ} ) \cdot {e}^{j 2 π {f}_{D} {iTS}_{sym}} = \frac{1}{{N}_{total}} {\sum }_{q = 0}^{Q - 1} {\sum }_{p = 0}^{P - 1} {\sum }_{m = 0}^{M - 1} {X}_{i} ( Ψ + {F}_{i} ) {e}^{j 2 π {f}_{D} {iTS}_{sym}} {e}^{j 2 π \frac{\{ Ψ + {F}_{i} \} ( {N}_{t otal - {N}_{C P} + {N}_{C P} + h L + {m}^{′} - {N}_{τ} )}}{{N}_{t o t a l}}} = \frac{1}{{N}_{total}} {\sum }_{q = 0}^{Q - 1} {\sum }_{p = 0}^{P - 1} {\sum }_{m = 0}^{M - 1} {X}_{i} ( Ψ + {F}_{i} ) {e}^{j 2 π {f}_{D} {iTS}_{sym}} {e}^{j 2 π \frac{\{ Ψ + {F}_{i} \} ( {m}^{′} - {N}_{τ} )}{{N}_{t o t a l}}} {e}^{j 2 π \frac{{F}_{i} h L}{{N}_{t o t a l}}}$$

where

$$0 \leq {N}_{τ} \leq min ( {N}_{c p} + \frac{N l}{{s}_{s u b}} , N ) ,$$

m′=0, 1, . . . Nₜₒₜₐₗ−hL−1.

Secondly, compensate phase rotation

$${e}^{j 2 π \frac{- {F}_{i} h L}{{N}_{total}}} :$$

$${G}^{′} ( {m}^{′} ) = G ( {m}^{′} ) {e}^{j 2 π \frac{- {F}_{i} h L}{{N}_{t o t a l}}} = \frac{1}{{N}_{total}} {\sum }_{q = 0}^{Q - 1} {\sum }_{p = 0}^{P - 1} {\sum }_{m = 0}^{M - 1} {X}_{i} ( Ψ + {F}_{i} ) {e}^{j 2 π {f}_{D} {iTS}_{sym}} {e}^{j 2 π \frac{\{ Ψ + {F}_{i} \} ( {m}^{′} - {N}_{τ} )}{{N}_{t o t a l}}}$$

Then frequency sequence X′ᵢ is obtained by apply FFT to time sequence G′, which is represented as:

$${X}_{i}^{′} ( {k}^{′} ) = {\sum }_{{m}^{′} = 0}^{{N}_{t otal} - 1} {G}^{′} ( {m}^{′} ) {e}^{j 2 π \frac{{m}^{′} {k}^{′}}{{N}_{t o t a l}}} = \frac{1}{{N}_{total}} {\sum }_{{m}^{′} = 0}^{{N}_{t o t a l - 1}} {\sum }_{q = 0}^{Q - 1} {\sum }_{p = 0}^{P - 1} {\sum }_{m = 0}^{M - 1} {X}_{i} ( Ψ + {F}_{i} ) {e}^{j 2 π {f}_{D} {iTS}_{sym}} {e}^{j 2 π \frac{\{ Ψ + {F}_{i} \} ( {m}^{′} - {N}_{τ} )}{{N}_{t o t a l}}} {e}^{j 2 π \frac{{m}^{′} {k}^{′}}{{N}_{t o t a l}}} = \frac{1}{{N}_{total}} {\sum }_{q = 0}^{Q - 1} {\sum }_{p = 0}^{P - 1} {\sum }_{m = 0}^{M - 1} {X}_{i} ( Ψ + {F}_{i} ) {e}^{j 2 π \frac{\{ Ψ + {F}_{i} \} {N}_{τ}}{{N}_{t o t a l}}} {e}^{j 2 π {f}_{D} i T {S}_{s y m}} {\sum }_{{m}^{′} = 0}^{{N}_{t otal} - 1} {e}^{j 2 π \frac{\{ Ψ + {F}_{i} \} {m}^{′}}{{N}_{t o t a l}}} {e}^{j 2 π \frac{{m}^{′} {k}^{′}}{{N}_{t o t a l}}}$$

Finally, X′ᵢ(k′) is represented as:

$${X}_{i}^{′} ( {k}^{′} ) = \{ \begin{matrix}\frac{Γ - h}{Γ} {X}_{i} ( Ψ + {F}_{i} ) {e}^{j 2 π \frac{\{ Ψ + {F}_{i} \} {N}_{τ}}{{N}_{total}}} {e}^{j 2 π {f}_{D} i T {S}_{s y m}} \\ 0 , otherwise\end{matrix} , {k}^{′} = Ψ + {F}_{i}$$

The length of the FFT at the receiver side may also be selected as (Γ−h)L, and is not limited thereto. For ease of description and analysis, the above example assumes that the FFT length at the receiver side is Nₜₒₜₐₗ.

Therefore, the sensing receiver recovers the transmitter's signal Xᵢ, and at this point, the distance detection range free from symbol signal interference has been extended to:

$$min ( {T}_{c p} + \frac{h}{Γ} {T}_{s} , {T}_{s} ) ,$$

thereby increasing the sensing range and avoiding ISI.

### Illustrative Implementations

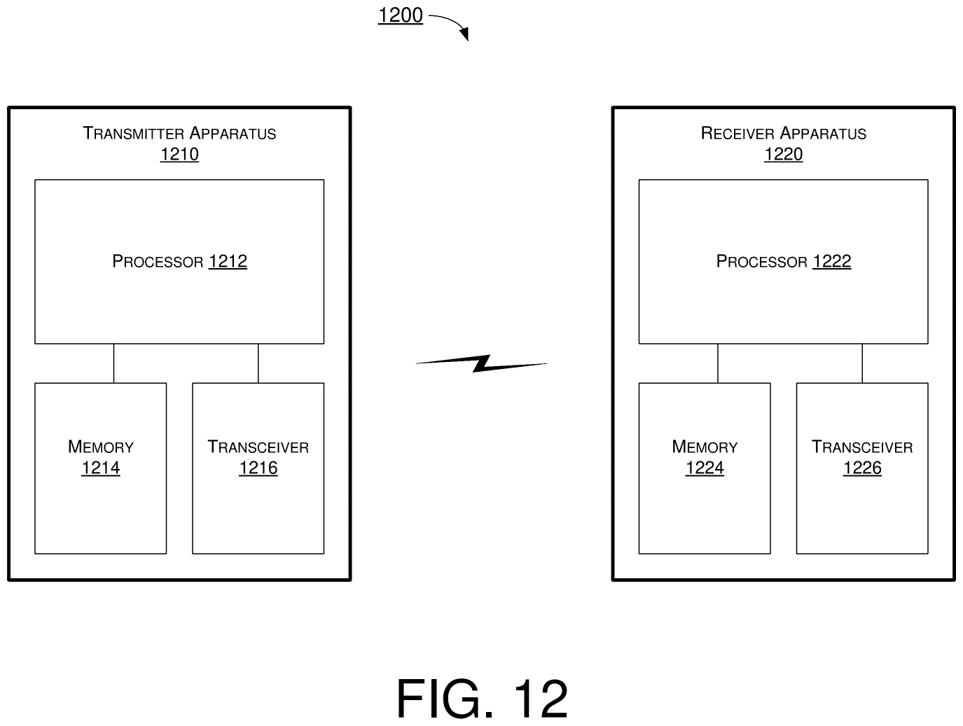

FIG. 12 illustrates an example communication system 1200 having an example transmitter apparatus 1210 and an example receiver apparatus 1220 in accordance with an implementation of the present disclosure. Each of transmitter apparatus 1210 and receiver apparatus 1220 may perform various functions to implement schemes, techniques, processes and methods described herein pertaining to RS transmission with respect to transmitter and receiver in mobile communications, including scenarios/schemes described above as well as processes 1300 and 1400 described below.

Transmitter apparatus 1210 may be: (1) a part of an electronic apparatus, which may be a UE such as a portable or mobile apparatus, a wearable apparatus, a wireless communication apparatus or a computing apparatus, or (2) a part of a network apparatus, which may be a network node such as a satellite, a base station, a small cell, a router or a gateway. For instance, transmitter apparatus 1210 may be implemented in a smartphone, a smartwatch, a personal digital assistant, a digital camera, or a computing equipment such as a tablet computer, a laptop computer or a notebook computer. Transmitter apparatus 1210 may also be a part of a machine type apparatus, which may be an IoT, NB-IoT, or IIoT apparatus such as an immobile or a stationary apparatus, a home apparatus, a wire communication apparatus or a computing apparatus. For instance, transmitter apparatus 1210 may be implemented in a smart thermostat, a smart fridge, a smart door lock, a wireless speaker or a home control center. For instance, transmitter apparatus 1210 may be implemented in an eNodeB in an LTE network, in a gNB in a 5G/NR, IoT, NB-IoT or IIoT network or in a satellite or base station in a 6G network. Alternatively, transmitter apparatus 1210 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Transmitter apparatus 1210 may include at least some of those components shown in FIG. 12 such as a processor 1212, for example. Transmitter apparatus 1210 may further include one or more other components not pertinent to the proposed scheme of the present disclosure (e.g., internal power supply, display device and/or user interface device), and, thus, such component(s) of transmitter apparatus 1210 are neither shown in FIG. 12 nor described below in the interest of simplicity and brevity.

In one aspect, processor 1212 may be implemented in the form of one or more single-core processors, one or more multi-core processors, or one or more CISC processors. That is, even though a singular term “a processor” is used herein to refer to processor 1212, processor 1212 may include multiple processors in some implementations and a single processor in other implementations in accordance with the present disclosure. In another aspect, processor 1212 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, processor 1212 is a special-purpose machine specifically designed, arranged and configured to perform specific tasks including RS transmission in a device (e.g., as represented by transmitter apparatus 1210) in accordance with various implementations of the present disclosure.

In some implementations, transmitter apparatus 1210 may also include a transceiver 1216 coupled to processor 1212 and capable of wirelessly transmitting and receiving data. In other words, processor 1212 may transceive the data such as configuration, message, signal, information, indicator, etc. via transceiver 1216. In some implementations, transceiver 1216 may include a plurality of transmitting antennas and one or more receiving antennas. In some implementations, transmitter apparatus 1210 may further include a memory 1214 coupled to processor 1212 and capable of being accessed by processor 1212 and storing data therein. Accordingly, transmitter apparatus 1210 may wirelessly communicate with other network node via transceiver 1216.

In some implementations, memory 1214 may include a type of random-access memory (RAM) such as dynamic RAM (DRAM), static RAM (SRAM), thyristor RAM (T-RAM) and/or zero-capacitor RAM (Z-RAM). Alternatively, or additionally, memory 1214 may include a type of read-only memory (ROM) such as mask ROM, programmable ROM (PROM), erasable programmable ROM (EPROM) and/or electrically erasable programmable ROM (EEPROM). Alternatively, or additionally, memory 1214 may include a type of non-volatile random-access memory (NVRAM) such as flash memory, solid-state memory, ferroelectric RAM (FeRAM), magnetoresistive RAM (MRAM) and/or phase-change memory.

Receiver apparatus 1220 may be: (1) a part of an electronic apparatus, which may be a UE such as a portable or mobile apparatus, a wearable apparatus, a wireless communication apparatus or a computing apparatus, or (2) a part of a network apparatus, which may be a network node such as a satellite, a base station, a small cell, a router or a gateway. For instance, receiver apparatus 1220 may be implemented in a smartphone, a smartwatch, a personal digital assistant, a digital camera, or a computing equipment such as a tablet computer, a laptop computer or a notebook computer. Receiver apparatus 1220 may also be a part of a machine type apparatus, which may be an IoT, NB-IoT, or IIoT apparatus such as an immobile or a stationary apparatus, a home apparatus, a wire communication apparatus or a computing apparatus. For instance, receiver apparatus 1220 may be implemented in a smart thermostat, a smart fridge, a smart door lock, a wireless speaker or a home control center. For instance, receiver apparatus 1220 may be implemented in an eNodeB in an LTE network, in a gNB in a 5G/NR, IoT, NB-IoT or IIoT network or in a satellite or base station in a 6G network. Alternatively, receiver apparatus 1220 may be implemented in the form of one or more IC chips such as, for example and without limitation, one or more single-core processors, one or more multi-core processors, one or more RISC processors, or one or more CISC processors. Receiver apparatus 1220 may include at least some of those components shown in FIG. 12 such as a processor 1222, for example. Receiver apparatus 1220 may further include one or more other components not pertinent to the proposed scheme of the present disclosure (e.g., internal power supply, display device and/or user interface device), and, thus, such component(s) of receiver apparatus 1220 are neither shown in FIG. 12 nor described below in the interest of simplicity and brevity.

In one aspect, processor 1222 may be implemented in the form of one or more single-core processors, one or more multi-core processors, or one or more CISC processors. That is, even though a singular term “a processor” is used herein to refer to processor 1222, processor 1222 may include multiple processors in some implementations and a single processor in other implementations in accordance with the present disclosure. In another aspect, processor 1222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, processor 1222 is a special-purpose machine specifically designed, arranged and configured to perform specific tasks including RS transmission in a device (e.g., as represented by receiver apparatus 1220) in accordance with various implementations of the present disclosure.

In some implementations, receiver apparatus 1220 may also include a transceiver 1226 coupled to processor 1222 and capable of wirelessly transmitting and receiving data. In other words, processor 1222 may transceive the data such as configuration, message, signal, information, indicator, etc. via transceiver 1226. In some implementations, transceiver 1226 may include a plurality of transmitting antennas and one or more receiving antennas. In some implementations, receiver apparatus 1220 may further include a memory 1224 coupled to processor 1222 and capable of being accessed by processor 1222 and storing data therein. Accordingly, receiver apparatus 1220 may wirelessly communicate with other network node via transceiver 1226.

In some implementations, memory 1224 may include a type of RAM such as DRAM, SRAM, T-RAM and/or Z-RAM. Alternatively, or additionally, memory 1224 may include a type of ROM such as mask ROM, PROM, EPROM and/or EEPROM. Alternatively, or additionally, memory 1224 may include a type of NVRAM such as flash memory, solid-state memory, FeRAM, MRAM and/or phase-change memory.

It should be noted that, in FIG. 12, example communication system 1200 is illustrated in the context of a bistatic sensing architecture for ISAC systems. However, in some embodiments, the transmitter apparatus 1210 and the receiver apparatus 1220 may be co-located (i.e., implemented as a single apparatus) thereby forming a monostatic sensing architecture for ISAC systems. Such monostatic configurations are not described in detail in the present disclosure.

### Illustrative Processes

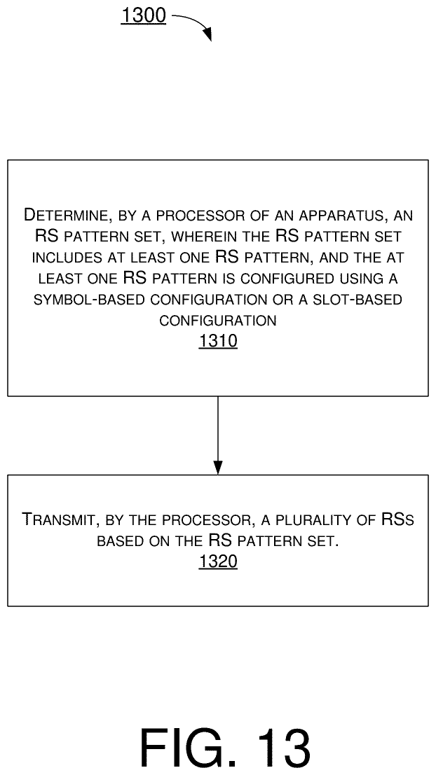

FIG. 13 illustrates an example process 1300 in accordance with an implementation of the present disclosure. Process 1300 may be an example implementation of above scenarios/schemes, whether partially or completely, with respect to RS transmission of the present disclosure. Process 1300 may represent an aspect of implementation of features of transmitter apparatus 1210. Process 1300 may include one or more operations, actions, or functions as illustrated by one or more of blocks 1310 and 1320. Although illustrated as discrete blocks, various blocks of process 1300 may be divided into additional blocks, combined into fewer blocks, or eliminated, depending on the desired implementation. Moreover, the blocks of process 1300 may be executed in the order shown in FIG. 13 or, alternatively, in a different order. Process 1300 may be implemented by transmitter apparatus 1210 or any suitable UE, base station or machine type devices. Solely for illustrative purposes and without limitation, process 1300 is described below in the context of transmitter apparatus 1210. Process 1300 may begin at block 1310.

At block 1310, process 1300 may involve processor 1212 of transmitter apparatus 1210 determining an RS pattern set. The RS pattern set may include at least one RS pattern, and the at least one RS pattern may be configured using a symbol-based configuration or a slot-based configuration. Process 1300 may proceed from block 1310 to block 1320.

At block 1320, process 1300 may involve processor 1212 of transmitter apparatus 1210 transmitting a plurality of RSs based on the RS pattern set.

In some implementations, the at least one RS pattern may include a plurality of RS patterns configured across at least one of a time domain and a frequency domain.

In some implementations, the plurality of RS patterns may be configured across the time domain, the RS pattern set may include at least one RS burst, and each RS burst may include at least one RS pattern.

In some implementations, a plurality of parameters associated with the RS pattern set may include at least one of: a first RE spacing between two REs within one symbol carrying RSs, a staggering offset for each symbol carrying RSs, a symbol spacing between two symbols carrying RSs within one RS pattern, a number of RS patterns in one RS burst, a number of symbols used in one RS burst, a burst spacing between two RS bursts, a number of RS bursts in the RS pattern set, and an RS pattern set spacing between the RS pattern set and another RS pattern set.

In some implementations, any two of the symbol spacing, the burst spacing and the RS pattern set spacing are arranged to achieve maximum doppler unambiguous range.

In some implementations, the staggering offsets for different symbols in the RS pattern may be the same or different.

In some implementations, the plurality of RS patterns may be configured across the frequency domain, the RS pattern set may include at least one RS burst, and each RS burst may include at least one RS pattern.

In some implementations, a plurality of parameters associated with the RS pattern set may include at least one of: a first RE spacing between two REs within one symbol carrying RSs, a staggering offset for each symbol carrying RSs, a symbol spacing between two symbols carrying RSs within one RS pattern, a number of RS patterns in one RS burst, a number of symbols used in one RS burst, a second RE spacing between one RE of one RS burst and another RE of adjacent RS burst, a number of RS bursts in the RS pattern set, and a third RE spacing between one RE of the RS pattern set and another RE of adjacent RS pattern set.

In some implementations, the first RE spacing, the second RE spacing and the third RE spacing may have a common factor greater than 1.

In some implementations, process 1300 may involve processor 1212 of transmitter apparatus 1210 applying an IFFT to each symbol of the plurality of RSs to obtain a plurality of time domain RSs. Each time-domain RS may include a plurality of segments, and each segment may be associated with at least one other segment. Process 1300 may involve processor 1212 of transmitter apparatus 1210 combining one or more segments of the plurality of segments with a CP to obtain an extended CP in each time-domain RS. Process 1300 may involve processor 1212 of transmitter apparatus 1210 transmitting the plurality of time domain RSs with the extended CPs.

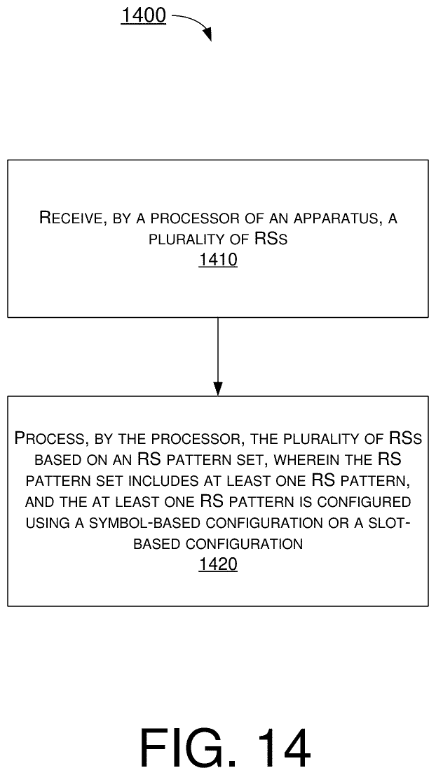

FIG. 14 illustrates an example process 1400 in accordance with an implementation of the present disclosure. Process 1400 may be an example implementation of above scenarios/schemes, whether partially or completely, with respect to RS transmission of the present disclosure. Process 1400 may represent an aspect of implementation of features of receiver apparatus 1220. Process 1400 may include one or more operations, actions, or functions as illustrated by one or more of blocks 1410 and 1420. Although illustrated as discrete blocks, various blocks of process 1400 may be divided into additional blocks, combined into fewer blocks, or eliminated, depending on the desired implementation. Moreover, the blocks of process 1400 may be executed in the order shown in FIG. 14 or, alternatively, in a different order. Process 1400 may be implemented by receiver apparatus 1220 or any suitable UE, base station, or machine type devices. Solely for illustrative purposes and without limitation, process 1400 is described below in the context of receiver apparatus 1220. Process 1400 may begin at block 1410.

At block 1410, process 1400 may involve processor 1222 of receiver apparatus 1220 receiving a plurality of RSs. Process 1400 may proceed from block 1410 to block 1420.

At block 1420, process 1400 may involve processor 1222 of receiver apparatus 1220 processing the plurality of RSs based on an RS pattern set. The RS pattern set may include at least one RS pattern, and the at least one RS pattern may be configured using a symbol-based configuration or a slot-based configuration.

In some implementations, the at least one RS pattern may include a plurality of RS patterns configured across at least one of a time domain and a frequency domain.

In some implementations, the plurality of RS patterns may be configured across the time domain, the RS pattern set may include at least one RS burst, and each RS burst may include at least one RS pattern.

In some implementations, a plurality of parameters associated with the RS pattern set may include at least one of: a first RE spacing between two REs within one symbol carrying RSs, a staggering offset for each symbol carrying RSs, a symbol spacing between two symbols carrying RSs within one RS pattern, a number of RS patterns in one RS burst, a number of symbols used in one RS burst, a burst spacing between two RS bursts, a number of RS bursts in the RS pattern set, and an RS pattern set spacing between the RS pattern set and another RS pattern set.

In some implementations, any two of the symbol spacing, the burst spacing and the RS pattern set spacing are arranged to achieve maximum doppler unambiguous range.

In some implementations, the staggering offsets for different symbols in the RS pattern may be the same or different.

In some implementations, the plurality of RS patterns may be configured across the frequency domain, the RS pattern set may include at least one RS burst, and each RS burst may include at least one RS pattern.

In some implementations, a plurality of parameters associated with the RS pattern set may include at least one of: a first RE spacing between two REs within one symbol carrying RSs, a staggering offset for each symbol carrying RSs, a symbol spacing between two symbols carrying RSs within one RS pattern, a number of RS patterns in one RS burst, a number of symbols used in one RS burst, a second RE spacing between one RE of one RS burst and another RE of adjacent RS burst, a number of RS bursts in the RS pattern set, and a third RE spacing between one RE of the RS pattern set and another RE of adjacent RS pattern set.

In some implementations, the first RE spacing, the second RE spacing and the third RE spacing may have a common factor greater than 1.

In some implementations, process 1400 may involve processor 1222 of receiver apparatus 1220 receiving a plurality of time domain RSs. Each time-domain RS may include an extended CP. Process 1400 may involve processor 1222 of receiver apparatus 1220 removing the extended CP from each time-domain RS to obtain one or more first segments in each time-domain RS. Process 1400 may involve processor 1222 of receiver apparatus 1220 determining one or more second segments based on the one or more first segments in each time-domain RS. Process 1400 may involve processor 1222 of receiver apparatus 1220 applying an FFT to each time-domain RS including the one or more second segments and the one or more first segments to obtain a plurality of RSs.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, a Reference Signal (RS) pattern set, wherein the RS pattern set includes at least one RS pattern, and the at least one RS pattern is configured using a symbol-based configuration or a slot-based configuration; and
transmitting, by the processor, a plurality of RSs based on the RS pattern set.

2. The method of claim 1, wherein the at least one RS pattern includes a plurality of RS patterns configured across at least one of a time domain and a frequency domain.

3. The method of claim 2, wherein the plurality of RS patterns are configured across the time domain, the RS pattern set includes at least one RS burst, and each RS burst includes at least one RS pattern.

4. The method of claim 3, wherein a plurality of parameters associated with the RS pattern set include at least one of:
a first Resource Element (RE) spacing between two REs within one symbol carrying RSs;
a staggering offset for each symbol carrying RSs;
a symbol spacing between two symbols carrying RSs within one RS pattern;
a number of RS patterns in one RS burst;
a number of symbols used in one RS burst;
a burst spacing between two RS bursts;
a number of RS bursts in the RS pattern set; and
an RS pattern set spacing between the RS pattern set and another RS pattern set.

5. The method of claim 4, wherein any two of the symbol spacing, the burst spacing and the RS pattern set spacing are arranged to achieve maximum doppler unambiguous range.

6. The method of claim 4, wherein the staggering offsets for different symbols in the RS pattern are the same or different.

7. The method of claim 2, wherein the plurality of RS patterns are configured across the frequency domain, the RS pattern set includes at least one RS burst, and each RS burst includes at least one RS pattern.

8. The method of claim 7, wherein a plurality of parameters associated with the RS pattern set include at least one of:
a first Resource Element (RE) spacing between two REs within one symbol carrying RSs;
a staggering offset for each symbol carrying RSs;
a symbol spacing between two symbols carrying RSs within one RS pattern;
a number of RS patterns in one RS burst;
a number of symbols used in one RS burst;
a second RE spacing between one RE of one RS burst and another RE of adjacent RS burst;
a number of RS bursts in the RS pattern set; and
a third RE spacing between one RE of the RS pattern set and another RE of adjacent RS pattern set.

9. The method of claim 8, wherein the first RE spacing, the second RE spacing and the third RE spacing have a common factor greater than 1.

10. The method of claim 1, wherein the transmitting of the plurality of RSs based on the RS pattern set further comprises:
applying, by the processor, an Inverse Fast Fourier Transform (IFFT) to each symbol of the plurality of RSs to obtain a plurality of time domain RSs, wherein each symbol of the plurality of time-domain RSs includes a plurality of segments, and each segment is associated with at least one other segment;
combining, by the processor, one or more segments of the plurality of segments with a Cyclic Prefix (CP) to obtain an extended CP in each symbol of the plurality of time-domain RSs; and
transmitting, by the processor, the plurality of time domain RSs with the extended CPs.

11. A method, comprising:
receiving, by a processor of an apparatus, a plurality of Reference Signals (RSs); and
processing, by the processor, the plurality of RSs based on an RS pattern set, wherein the RS pattern set includes at least one RS pattern, and the at least one RS pattern is configured using a symbol-based configuration or a slot-based configuration.

12. The method of claim 11, wherein the at least on RS pattern includes a plurality of RS patterns configured across at least one of a time domain and a frequency domain.

13. The method of claim 12, wherein the plurality of RS patterns are configured across the time domain, the RS pattern set includes at least one RS burst, and each RS burst includes at least one RS patterns.

14. The method of claim 13, wherein a plurality of parameters associated with the plurality of RS pattern set include at least one of:
a first Resource Element (RE) spacing between two REs within one symbol carrying RSs;
a staggering offset for each symbol carrying RSs;
a symbol spacing between two symbols carrying RSs within one RS pattern;
a number of RS patterns in one RS burst;
a number of symbols used in one RS burst;
a burst spacing between two RS bursts; and
a number of RS bursts in the RS pattern set;
a RS pattern set spacing between the RS pattern set and another RS pattern set.

15. The method of claim 14, wherein the staggering offsets for different symbols in the RS pattern are the same or different.

16. The method of claim 12, wherein the plurality of RS patterns are configured across the frequency domain, the RS pattern set includes at least one RS burst, and each RS burst includes at least two RS patterns.

17. The method of claim 16, wherein a plurality of parameters associated with the RS pattern set include at least one of:
a first Resource Element (RE) spacing between two REs within one symbol carrying RSs;
a staggering offset for each symbol carrying RSs;
a symbol spacing between two symbols carrying RSs within one RS pattern;
a number of RS patterns in one RS burst;
a number of symbols used in one RS burst;
a second RE spacing between one RE of one RS burst and another RE of adjacent RS burst;
a number of RS bursts in the RS pattern set; and
a third RE spacing between one RE of the RS pattern set and another RE of adjacent RS pattern set.

18. The method of claim 17, wherein the first RE spacing, the second RE spacing and the third RE spacing have a common factor greater than 1.

19. The method of claim 11, wherein the receiving of the plurality of RSs further comprises:
receiving, by the processor, a plurality of time domain RSs, wherein each symbol of the plurality of time-domain RSs includes an extended Cyclic Prefix (CP);
wherein the processing of the plurality of RSs based on the RS pattern set further comprises:
removing, by the processor, the extended CP from each symbol of the plurality of time-domain RSs to obtain one or more first segments in each symbol of the plurality of time-domain RSs;
determining, by the processor, one or more second segments based on the one or more first segments in each symbol of the plurality of time-domain RSs; and
applying, by the processor, a Fast Fourier Transform (FFT) to each symbol of the plurality of time-domain RSs including the one or more second segments and the one or more first segments to obtain the plurality of RSs.

20. An apparatus, comprising:
a transceiver which, during operation, wirelessly communicates with a wireless network; and
a processor communicatively coupled to the transceiver such that, during operation, the processor performs operations comprising:
determining a Reference Signal (RS) pattern set, wherein the RS pattern set includes at least one RS pattern, and the at least one RS pattern is configured using a symbol-based configuration or a slot-based configuration; and
transmitting, via the transceiver, a plurality of RSs based on the RS pattern set.
